(19) United States
(12) Patent Application Publication
(10) Pub. No.: US 2025/0073830 A1
(43) Pub. Date: Mar. 6, 2025

(54) AUTOMATED SHRINK-FITTING CELL

(71) Applicant: Franz Haimer Maschinenbau KG, Hollenbach-Igenhausen (DE)

(72) Inventors: Franz Haimer, Hollenbach-Igenhausen (DE); Andreas Haimer, Hollenbach-Igenhausen (DE)

(21) Appl. No.: 18/826,464

(22) Filed: Sep. 6, 2024

(30) Foreign Application Priority Data
Sep. 6, 2023 (DE) 10 2023 124 026.9
Mar. 22, 2024 (DE) 10 2024 108 330.1
Aug. 1, 2024 (DE) 10 2024 122 028.7

(51) Int. Cl. B23P 11/02

(52) U.S. Cl. CPC B23P 11/027

(57) ABSTRACT

A shrink-fitting apparatus and method for the automated shrink-fitting a tool into and out of a tool holder, and a conveying box for tool holders and/or tools. The tool may be a rotary tool, such as a milling cutter, a drill, or the like. The tool holder may be a shrink-fit receptacle. The apparatus has a first multiaxial handling apparatus for transferring tool holders and tools in the shrink-fitting apparatus. Accuracy is ensured for loading the tool holder with tools by way of shrink-fitting in an automated overall process for automated production of workpieces, by providing the shrink-fitting apparatus with a second, automatically displaceable handling apparatus. The handling apparatus has a uniaxial linear drive for automatically displacing the tool along one axis (Z axis) relative to the tool holder during the shrink-fitting and/or removal operation.

The invention relates to a shrink-fitting apparatus for the automated shrink-fitting and removal of a tool into and from a tool holder, and to a method for the automated shrink-fitting and removal of a tool into and from a tool holder. The invention also relates to a conveying box for tool holders and/or tools.

DE 10 2016 208 505 A1 discloses such a shrink-fitting apparatus for the automated shrink-fitting and removal of a tool into and from a tool holder and such a method.

It is known practice to widen tool holders, which hold a shaft of a tool, in particular a rotary tool, such as a drill, a milling cutter or a sanding tool, in a press fit in a central receiving opening of the tool holder, in the region of this receiving opening by heating, in order to be able to insert or remove the shaft of the tool (thermal shrink-fitting and/or removal or in short simply shrink-fitting and/or removal).

For this, use is usually made of what are referred to as shrink-fitting units-and induction heating devices installed there for the heating of the tool holder, in which induction heating devices eddy currents are induced in the tool holder by means of an induction coil arrangement via a transformer.

In the heating phase, which lasts only a few seconds, the tool holder (located in the shrink-fitting unit) is heated in the region of the receiving opening to several 100° C. (, with the region of the receiving opening of the tool holder being widened as a result—so that the shaft of the tool inserts there, or the tool can be removed).

In order to make the cooling phase of the tool holder shorter (and possibly also increase the operational safety during the shrink-fitting operation), the tool holder is then cooled down by blowing an air flow onto it or by means of a cooling sleeve through which coolant flows.

Continuing automation of industrial processes has meant that the shrink-fitting process has also become largely automated in the last few years, and in this case it is not just the actual shrink-fitting operation by the shrink-fitting unit, as illustrated, that has been automated but also processes which are upstream and downstream—of the actual shrink-fitting operation—, such as the feed and withdrawal of tool holders and tools to and from the shrink-fitting unit or else the cooling (of a tool holder after the shrink-fitting operation), a balancing operation and/or a presetting operation,—which are processes that must be integrated for automated shrink-fitting in the overall process of industrial automated manufacturing.

That is to say, such an automated shrink-fitting apparatus, which is often, or usually, also referred to simply as automated shrink-fitting cell, or the shrink-fitting apparatus for the automated shrink-fitting and removal of a tool into and from a tool holder, makes it possible to load a tool holder with a tool, or perform a tool exchange at a tool holder, in automated fashion virtually without manual intervention—in the overall process of automated production of workpieces.

Again for clarification—a shrink-fitting apparatus (for the automated shrink-fitting and removal of a tool into and from a tool holder), or an (automated) shrink-fitting cell, means a complex industrial facility which thus—indeed—comprises the shrink-fitting unit—for the (actual) shrink-fitting and removal of tools into and from a tool holder—as an absolutely essential constituent part, but in addition also comprises a plurality of various other important constituent parts, such as handling units or industrial robots/arms and/or conveyor devices/belts, which bring about processes upstream and downstream of the (actual) shrink-fitting operation in the shrink—fitting unit—and thus enable a complex automated (overall) process-in the form of a process that must be integrated for automated shrink-fitting in the overall process of industrial automated manufacturing.

That is to say, reducing a shrink-fitting apparatus (for automated shrink-fitting and removal of a tool into and from a tool holder) or an (automated) shrink-fitting cell to a or the shrink-fitting unit falls short of the mark.

Such a shrink-fitting apparatus for the automated shrink-fitting and removal of a tool into and from a tool holder or an automated shrink-fitting cell is known from the already mentioned DE 10 2016 208 505 A1.

This shrink-fitting apparatus for the automated shrink-fitting and/or removal of a tool into and/or from a tool holder provides a shrink-fitting unit for shrink-fitting and/or removal of a tool into and/or from a tool holder and—in this case—multiple multiaxial handling apparatuses (gripper/robot arms) for transferring tool holders and tools in the shrink-fitting apparatus.

To the extent that this shrink-fitting apparatus from DE 10 2016 208 505 A1 provides automation of the actual shrink-fitting operation in the shrink-fitting unit of the apparatus, that document provides that the tool can be inserted into or removed from the thermally widened receiving opening of the tool holder by hand (or by means of a handling apparatus not described in more detail—only the multiaxial robot arm is described to this extent) in automated fashion.

A disadvantage of such automated shrink-fitting apparatuses and cells can be that inserting the tool into the tool holder during the shrink—fitting operation—manually or by means of aforementioned handling units, or multiaxial robot arms, has an adverse effect on accuracy during the shrink-fitting operation.

An object of the invention is to improve the automated shrink-fitting apparatuses or cells known from the prior art to the extent that they enable automated shrink-fitting and removal with high accuracy together with high operational safety and high efficiency and effectiveness.

This object is achieved by a shrink-fitting apparatus for the automated shrink-fitting and removal of a tool into and from a tool holder and by a method for the automated shrink-fitting and removal of a tool into and from a tool holder, and also by a conveying box for tool holders and/or tools, having the features of the respective independent claim.

Advantageous developments of the invention are the subject of dependent claims and the following description—and refer to both the units and the methods.

Any terms used, such as above, below, front, rear, left or right—unless explicitly defined otherwise—are to be understood according to the usual understanding—also with regard to the present figures. Terms such as radial and axial, where used and not explicitly defined otherwise, are to be understood with reference to central or symmetry axes of components described here—also with regard to the present figures.

The term “substantially”—where used—can be understood (according to the highest court's understanding) as referring to “a practically still considerable extent”. Possible deviations from exactness that are thus implied by this term may therefore arise unintentionally (that is to say without any functional basis) owing to manufacturing or assembly tolerances or the like.

The shrink-fitting apparatus for the automated shrink-fitting and removal of a tool, such as a rotary and/or rotational tool, such as a milling cutter, a drill and the like, into and from a tool holder, such as in particular a shrink-fit receptacle, provides a shrink-fitting unit for shrink-fitting and/or removal of a tool into and/or from a tool holder (which in the following text might also be referred to synonymously as tool receptacle) and a first multiaxial handling apparatus for transferring tool holders and tools in the shrink-fitting apparatus.

The shrink-fitting apparatus comprises a second, automatically displaceable handling apparatus. It provides a uniaxial linear drive, such that—by means of this uniaxial linear drive—the tool can be automatically displaced along this one (defined) axis (Z axis) relative to the tool holder during the shrink-fitting and/or removal operation.

The method for the automated shrink-fitting and removal of a tool into and from a tool holder, in particular using the shrink-fitting apparatus for the automated shrink-fitting and removal of a tool into and from a tool holder provides that a or the uniaxial linear drive of a or the second, automatically displaceable handling apparatus is used to automatically displace the tool along this one axis (Z axis) relative to the tool holder during the shrink-fitting and/or removal operation.

Although the following text only discusses a shrink-fitting apparatus, the invention can analogously also be applied to other cells with other ways of clamping tools than shrink-fitting, for example for collet receptacles, hydraulic expansion chucks, Weldon receptacles or face mill arbors.

This then involves, instead of the shrink-fitting unit, the corresponding other unit/apparatus (or, if appropriate, (multiple) other units/apparatuses (, in particular with different ways of clamping), which uses the other way of clamping for the tool—and which in particular however also can comprise the second, automatically displaceable handling apparatus according to the invention with its uniaxial linear drive (, by means of which the tool can then also in this case be automatically displaced along this one (defined) axis (Z axis) relative to the tool holder when being inserted into and/or taken out of the tool holder). The one or more other units/apparatuses—which use other ways of clamping—can also be implemented in the cell together with the shrink-fitting unit or else without the shrink-fitting unit.

In particular other apparatus parts, which relate to the actual operation of clamping-in or unclamping the tool, can also be correspondingly adapted. In particular a further handling unit is suitable here, which can be configured analogously to the first—and interacts with the other way of clamping.

If appropriate, it would thus then be possible in the case of other units for collet receptacles, hydraulic expansion chucks, Weldon receptacles or face mill arbors to, in automated fashion and by way of corresponding handling units, screw-fit or mount parts there, for example union nuts in the case of collets, or to fasten screws, for example pressure screws in the case of hydraulic expansion chucks or clamping screws in the case of Weldon receptacles. The corresponding screwing devices may be mounted for example fixedly on the apparatus and the chucks guided up to the screwing device, in particular using the first handling apparatus. Conversely, it is possible to move the screwing device by means in particular of the first handling apparatus to the chuck. In the latter case, the screwing device may be fixedly mounted on or gripped by the handling apparatus.

Expressed clearly and simply, the invention makes use—within the context of an automated overall process in a shrink-fitting cell—during the automatic insertion/extraction of a tool into/from a heated tool holder, i.e. during the actual shrink-fitting operation,—specifically not of one or the first multiaxial handling apparatus—but rather of a or the second, automatically displaceable handling apparatus having the uniaxial linear drive, which thus displaces the tool along this one (defined) axis (Z axis) during the shrink-fitting operation.

The invention is based on the finding that, according to what came before—where tools are displaced manually or by means of conventional multiaxial industrial robots during the shrink-fitting operation—the accuracy is usually reduced, manual manipulation does not make it possible to achieve a high or the sought-after accuracy, and/or axis errors in the case of the multiaxial industrial robots add up to afford greater overall errors, and therefore it also might not be possible to achieve the sought-after accuracy here, either. In particular when the tool is being introduced into the heated tool holder, slight deviations between the axis of the tool and the axis of the receiving bore of the tool holder can already lead to problems.

The invention helps with this—in that the second, automatically displaceable handling apparatus, provided in the case of the shrink-fitting apparatus and/or shrink-fitting cell and the method, by means of which, using its uniaxial linear drive, the tool can be automatically displaced along this one axis (Z axis) relative to the tool holder during the shrink-fitting and/or removal operation.

Axis errors virtually do not arise at all in the case of such a linear displaceability, as in the case of the invention.

This makes it possible to (during the shrink-fitting operation) highly precisely position a tool in the tool holder in a way that is superior to what came before in terms of accuracy; the shrink-fitting is made significantly more accurate, the degree of automation can be increased further—without needing to account for losses in the automation.

According to a preferred embodiment, which further increases the accuracy, of the shrink-fitting apparatus, it is provided that the second, automatedly displaceable handling apparatus comprises a gripper head which is rotatable about the one axis (Z axis), in particular having an angle measuring apparatus which can be used to measure a rotational position of the gripper head.

It may also be provided that the gripper head comprises multiple gripper apparatuses for gripping of tools, in particular that the multiple gripper apparatuses are arranged about an axis (Z axis), specifically evenly distributed, at a predefinable spacing. The gripper apparatuses may also be exchangeable, in particular also exchangeable in automated fashion.

It has proven to be expedient if the multiple gripper apparatuses are adapted to tools of predefinable diameters.

It is also advantageous if the gripper head comprises force measuring devices, which can be used to measure a tensile force and/or a shear force exerted by the gripper apparatus on a tool. In this case, the force measuring devices, for example load cells, may be installed in the gripper head or in the gripper apparatuses.

According to a preferred embodiment, it is provided that a or each of the gripper apparatuses has two gripper jaws, which during the gripping operation can be moved relative to one another, in particular electromotively displaced, and in particular are designed such that a gripping operation can be measured and/or monitored, in particular in terms of a gripping force.

It may also preferably be provided that one or each of the gripper jaws provides a stop lug.

Such a gripper jaw can also be arranged exchangably and/or positionally accurately clampably in the gripping apparatus.

It is also possible, in the case of the shrink-fitting apparatus, to provide a conveyor device for transportation of tool holders and tools to (or away from) the shrink-fitting unit, such as a carriage, in particular in the form of an autonomous, or driverless, transport system (ATS), or a pallet, or an in particular circulating, in particular segmented, conveyor belt. It is also possible to provide or integrate multiple conveyor belts having handover units for chaining process sequences and the tool feed.

It may furthermore also be provided that the shrink-fitting unit comprises at least one, in particular multiple holding devices, in particular spindles, which in particular are arranged next to one another and which can be used to hold tool holders in clamped fashion during the shrink-fitting operation. The holding devices may alternatively also be arranged in an axial or radial alignment on a pivoting apparatus or a turret, which is pivotable about a horizontal or vertical axis.

The shrink-fitting unit may also comprise at least one induction coil arrangement, in particular multiple induction coil arrangements, which in particular are arranged next to one another and/or are adapted and/or adaptable to tool holders and which can be used to heat tool holders.

Such an induction coil arrangement may provide means for cooling, in particular in the form of impact precooling, in order in particular to optimize process times and achieve faster clamping of the tool holder.

It is also possible for such an induction coil arrangement to provide a concentrator, or a stop disk or ferrite disk, which, in particular if a stop element, such as a stop lug in the case of the gripper apparatus, rests on the end face of the tool holder, may be slotted, in particular with a clearance or a gap.

Expediently, the at least one spindle of the shrink-fitting unit is horizontally and/or vertically displaceable, in particular having a lifting travel monitoring device, which can be used to monitor and/or measure a vertical displacement travel during the vertical displacement of a spindle.

It is also advantageous if the shrink-fitting unit comprises a collision monitoring apparatus, which can be used to detect a collision between a tool holder and an induction coil arrangement of the shrink-fitting unit.

It is also possible to provide a reading apparatus, which is arranged on the holding apparatus for the tool holder, in particular the spindle, or in particular on the first multiaxial handling apparatus, and/or which is designed such that, when a tool holder is held in clamped fashion in one of the spindles of the shrink-fitting unit, a marker applied to the tool holder, in particular a tool holder code, can be read in particular when the spindle is rotating.

It may also be expedient to provide a centering station for clamping and aligning a tool. For example, such a centering station may comprise clamping jaws, which center a tool as it is being clamped. It may be expedient in this case to arrange multiple such clamping jaws, for example three or four clamping jaws, symmetrically relative to one another, which then clamp a tool in centered fashion and can hold it in clamped fashion.

According to a preferred development, also provided is an alignment control device, which in particular is arranged in the region of the centering station and which can be used to determine and/or monitor an alignment of a tool, which in particular has been removed from the centering station by means of the second, automatically displaceable handling apparatus. Such an alignment control device may for example be a laser-based measuring system.

Furthermore, a measuring device, in particular a laser, is also expedient for measuring a workpiece.

It is furthermore also advantageous if the first multiaxial handling apparatus is a multiaxial articulated-arm robot.

It is also expedient if the first multiaxial handling apparatus or the multiaxial articulated-arm robot comprises a double gripper for gripping of a tool (on one side, a first gripper) and for gripping of a tool holder (on the other side, second gripper).

It is also expedient to provide a cooling station for cooling, in particular of tool holders heated by the shrink-fitting operation.

Such a cooling station may provide multiple holding devices, in particular spindles, which in particular are arranged next to one another and which can be used to hold tool holders during the cooling operation. The holding devices may alternatively also be arranged in an axial or radial alignment on a pivoting apparatus or a turret, which is pivotable about a horizontal or vertical axis.

It is also expedient if the cooling station provides a cooling attachment, which can be fitted over tool holders held on the spindles.

The cooling attachment is preferably configured to generate an eddy-current cooling (cyclone cooling) effect. Such a cooling attachment is described for example in the laid-open specification for the application which has the official file reference DE 10 2022 114 046.6.

It is also expedient if, in the case of the shrink-fitting apparatus, a switching cabinet and/or balancing apparatus and/or a presetting apparatus and/or a cleaning apparatus and/or a control computer, on which control computer in particular a control program for a controller of the shrink-fitting apparatus is stored, are or is provided. The control computer may also provide a monitor, an input unit (for example a keyboard) and a printer.

It may also be expedient if, in the case of the shrink-fitting apparatus, a cleaning station, in particular ultrasonic cleaning means, in particular for cleaning, particularly preferably for cleaning and drying, of tools before the shrink-fitting operation and/or an induction coil arrangement with an exchangeable stop disk are/is provided.

The exchangeable stop disks may be exchanged in automated fashion, so that all of a very wide variety of tool receptacles (e.g. “ultra-short”) can be shrink-fitted.

Instead of or in addition to the ultrasonic cleaning means, it is also possible to provide nozzles with cleaning fluid such as water, air or oil. As an alternative, the cleaning station can also be provided with brushes, wiper bodies or sticky pads or the like.

The controller can also communicate with or incorporate or be incorporated in other process systems or process programs, such as a tool management program or the like. The controller may for example also itself in turn be a constituent part or be incorporated in the superordinate process environment or a superordinate process controller, in particular for industrial production or manufacture of workpieces. The shrink-fitting cell may thus be a (functionally, such as physically) integrated constituent part of a complex, industrial (overall) process environment.

It is also possible to provide a safety screen, for example in the form of a safety fence, in the case of the shrink-fitting apparatus, which can be used to screen in particular wide regions of the shrink-fitting apparatus from an area surrounding the shrink-fitting apparatus.

Such a safety screen or such a safety fence may also provide apertures, for example doors, in order thus to enable access to certain regions of the shrink-fitting apparatus. The doors may in particular be automatically lockable and/or unlockable.

It is also expedient if, in the case of the shrink-fitting apparatus and/or in the case of the method, at least one, in particular multiple ones or all, of the following method steps are carried out, in particular in the listed sequence:
(a) loading a conveying box, arranged on a conveyor device, with a tool (to undergo shrink-fitting) and/or a tool holder and/or with a tool holder having a tool (to be removed) or depositing a conveying box, filled with a tool (to undergo shrink-fitting) and a tool holder or a tool holder having a tool (to be removed), on a conveyor device,
(b) transporting a conveying box, loaded with a tool (to undergo shrink-fitting) and a tool holder or a tool holder having a tool (to be removed), by means of a conveyor device to the shrink-fitting unit, in particular to the vicinity of a (clamping) spindle of the shrink-fitting unit,
(c) transferring a tool holder from a conveying box to a spindle of the shrink-fitting unit, in particular using a first multiaxial handling apparatus for transferring tool holders and tools,
(d) clamping a tool holder on a spindle of the shrink-fitting unit,
(e) rotating a tool holder clamped on a spindle of the shrink-fitting unit, in particular about the one axis (Z axis) and in particular by 360°, and reading a marker applied to the tool holder, in particular a tool holder code applied to the tool holder,
(f) providing tool holder and/or tool and/or shrink-fit data or parameters, in particular using a marker applied to the tool holder and read, in particular a tool holder code applied to the tool holder and read,
(g) transferring a tool (to undergo shrink-fitting) from a conveying box to a centering station, in particular using a first multiaxial handling apparatus for transferring tool holders and tools,
(h) clamping and/or aligning a tool (to undergo shrink-fitting) in a centering station,
(i) gripping a tool (to undergo shrink-fitting), which is clamped in a centering station, by means of the second, automatically displaceable handling apparatus, in particular such that the tool (to undergo shrink-fitting) after the shrink-fitting operation into a tool holder has a predefinable position in the tool holder,
(j) measuring a tool (to undergo shrink-fitting) gripped by the second, automatically displaceable handling apparatus, in particular using a measuring laser and/or in particular measuring an alignment of the tool (to undergo shrink-fitting), in particular in terms of the one axis (Z axis) and/or measuring the length of the tool (to undergo shrink-fitting),
(k) displacing a tool holder clamped on a spindle of the shrink-fitting unit, in particular displacing the tool holder to underneath an induction coil arrangement of the shrink-fitting unit in the continuation of the one axis (Z axis),
(l) ascertaining a lifting travel of a tool holder clamped on a spindle of the shrink-fitting unit, in particular along the one axis (Z axis) and in particular using a geometry of the tool holder,
(m) lifting a tool holder clamped on a spindle of the shrink-fitting unit, in particular along the one axis (Z axis), in particular until the tool holder comes into abutment in an induction coil arrangement, in particular comes into abutment with stop disks of the induction coil arrangement,
(n) monitoring a lifting operation of a tool holder clamped on a spindle of the shrink-fitting unit in terms of a lifting travel and/or a collision with an induction coil arrangement, in particular a collision with stop disks of the induction coil arrangement,

(Removing an “old/used” tool from a tool holder and shrink-fitting a new tool into the tool holder)
(o) heating a tool holder using an induction coil arrangement of the shrink-fitting unit,
(p) gripping a tool (to be removed), which is arranged in a tool holder, by way of the second, automatically displaceable handling apparatus and displacing the tool (to be removed), that is gripped by the second, automatically displaceable handling apparatus, along the one axis (Z axis) out of the tool holder, in particular while monitoring the displacement of the gripped tool in terms of a tensile force exerted on the tool (to be removed),
(q) pivoting a gripper head of the second, automatically displaceable handling apparatus,
(r) displacing (inserting) a tool (to undergo shrink-fitting), that is gripped by the second, automatically displaceable handling apparatus, along the one axis (Z axis) relative to the tool holder into a predefinable shrink-fit position with respect to the tool holder, in particular displacing the tool (to undergo shrink-fitting), that is gripped by the second, automatically displaceable handling apparatus, along the one axis (Z axis) relative to the tool holder until gripper lugs of a gripper head of the second, automatically displaceable handling apparatus rest on an upper end face of the tool holder or on a stop disk of the induction coil arrangement, in particular while monitoring the displacement of the gripped tool in terms of a shear force exerted on the tool (to undergo shrink-fitting), (in the event of resting on the end face of the tool holder, the stop disk may be slotted, in particular with a clearance or a gap)
(s) temporarily holding a tool (to undergo shrink-fitting into a tool holder) by means of the second, automatically displaceable handling apparatus, in particular at least until the tool (to undergo shrink-fitting) is clamped by means of cooling the tool holder, and then detaching the tool,
(t) lowering a tool holder, that is clamped on a spindle of the shrink-fitting unit (and clamps a tool which has newly just undergone shrink-fitting), in particular along the one axis (Z axis),
(u) transferring a tool holder, that is clamped on a spindle of the shrink-fitting unit (and clamps a tool which has newly just undergone shrink-fitting), to a cooling station using a first multiaxial handling apparatus,
(v) cooling a tool holder (that clamps a tool which has newly just undergone shrink-fitting), in particular using an eddy-current cooling (cyclone cooling) effect,
(w) transferring a tool holder (that clamps a tool which has newly just undergone shrink-fitting) to a balancing apparatus and/or to a presetting apparatus using a first multiaxial handling apparatus,
(x) measuring a tool holder (that clamps a tool which has newly just undergone shrink-fitting), in particular in a presetting device or in a cooling station or in a balancing apparatus,
(y) displacing an (already removed) tool by means of the second, automatically displaceable handling apparatus, in particular to a conveying box and/or to a centering station,
(z) transferring a (cooled) tool holder to a conveying box.

It may also be expedient if a tool (to undergo shrink-fitting) is centered and/or aligned by rotating a tool holder while the tool (to undergo shrink-fitting) is being inserted into the tool holder. This may be provided for example as an alternative—or even as an addition—to the aforementioned centering station.

A further important aspect of the invention, which may also be made the subject of a divisional application—also independently of the shrink-fitting apparatus, i.e. independently of a specific clamping technique—in the course of/with a corresponding clamping or mounting method (for example thus also for an apparatus for mounting Weldon chucks or hydraulic expansion chucks, a pressing station for mounting of tools in chucks by pressing them in or a screwing apparatus in the case of/for mounting of collets and the like)—, is a monitoring and/or checking of the tool and/or monitoring and/or checking of the tool holder—in the shrink-fitting apparatus.

In this respect, as definition, the shrink-fitting apparatus can also (in general) be understood to be a mounting station.

A monitoring and/or checking of the tool and/or the tool holder can in particular also include a measurement and/or validation of the respective component. In this regard, it may be relevant—(in the shrink-fitting apparatus or in the system and/or process)—for the component that is to be processed, such as a tool and/or a tool holder, to be identified—for example by means of the aforementioned reading apparatus and code recognition in this respect—and thus data, values and the like about the component that is to be processed are known (cf. aforementioned reading apparatus and also steps e) and f)).

The monitoring and/or checking of the tool and/or monitoring and/or checking of the tool holder can expediently in particular be carried out
(1) on the tool holder (with or without a tool) before the shrink-fitting and/or removal operation, and/or
(2) on the tool, which is (then) to be shrink-fitted, and/or
(3) during the shrink-fitting and/or removal of a tool into and/or from the tool holder, it being the case here in particular then that corrections, in particular positional corrections can be made (in/during/at the same time as the (shrink-fitting) process)—on the basis of information obtained from the monitoring/measurement/validation, in particular geometric information and/or data and values.

For this, i.e. during the monitoring and/or checking of the tool and/or monitoring and/or checking of the tool holder (with or without a tool), it is possible to provide an—optionally—further measuring device, which then in particular or specifically is used to measure a tool and/or tool holder (with or without a tool).

During the monitoring and/or checking of the tool and/or monitoring and/or checking of the tool holder (with or without a tool), it is also possible to provide an—optionally—further holding apparatus, which can be used in particular, or specifically, to hold, in particular hold in clamped fashion, a tool holder and/or a tool, in particular while the further measuring device is being used to perform checking.

The further measuring device may also be used in the shrink-fitting apparatus instead of the aforementioned measuring apparatus (for example the laser) (or other measuring apparatuses possibly also used in the shrink-fitting apparatus). The same applies to the further holding apparatus—with respect to previously mentioned holding apparatuses/spindles.

For example—with the further measuring device and/or the further holding apparatus—it would be possible to replace the aforementioned centering station with them.

It seems to be expedient, in particular in order to be able to provide an efficient and/or highly accurate measuring system, for the further measuring device to be a transmitted-light or incident-light measuring system or operate on the transmitted-light or incident-light principle. It might also be possible to use a laser measuring system.

It is possible here in particular to achieve accuracy measurements measured in μm, in particular to within a h6 tolerance or even more accurately.

It also seems to be advantageous, in particular in order to reach all measurement positions (in the case of the tool and/or the tool holder (synonymously also tool receptacles)), and/or in order to be able to “scan” the entire tool and/or the entire tool holder and/or the entire overall tool (composed of tool and tool holder), if the further measuring device can be displaced at least in one, in particular in two spatial directions, in particular substantially along the one axis (Z axis) and/or substantially transversely to the one axis (Z axis). The further holding apparatus may also correspondingly provide, i.e. it is expedient here, if the further holding apparatus can be displaced horizontally, in particular substantially transversely to the one axis (Z axis), and/or vertically, in particular substantially along the one axis (Z axis). In particular, it is advantageous if the further holding apparatus is designed such that the clamped-in part of the tool shaft is also still accessible/visible for the measurement.

It is advantageous in particular also if the further holding apparatus is rotatable and/or comprises an in particular rotatable jaw chuck and/or a turntable, which is rotatable and/or movable in other spatial directions, and the held part can specifically thus be measured all around (360°), i.e. from all sides. As a result, it is possible in particular as a result also to measure a roundness or a cylindricity of the component (in particular during a monitoring and/or checking of the tool holder (with or without a tool) and/or the monitoring and/or checking of the tool). Other “peculiar features” in the geometry of the component, for example Weldon faces on the tool shaft, can also be detected particularly well in this way. Grip and/or hold regions (on the tool shaft) can also be identified or ascertained well in this way. For this, it is also advantageous to determine the actual length of the cutting-edge region, since the cylindrical shaft region available for gripping the tool becomes shorter, e.g. after resanding of the tool.

Similarly, however, the further measuring unit could also be rotated about the component or tool and/or tool holder/receptacle to be checked.

During the monitoring and/or checking of the tool receptacle, with or without a tool, and/or during the monitoring and/or checking of the tool, it is in particular expedient if the further measuring device is displaced substantially along the one axis (Z axis). This thus makes it possible to monitor and/or check and/or measure the component over its entire length, in particular also at its highest point. Other “particular” points (contour points), such as edges, projections and the like, can also be monitored and/or checked and/or measured in this way.

In particular, it is also expedient to use the further measuring device, in particular during the monitoring and/or checking of the tool receptacle, with or without a tool, and/or monitoring and/or checking of the tool, to measure a geometry, such as an overall length, in particular of the tool receptacle with a tool (in particular validated as “OK” or “in tolerance”), a tool length, a tool diameter, a shaft length, a projecting length, a cutting-edge length, a cutting slot length, a cutting-edge diameter, a tool shaft diameter, a roundness or cylindricity, in particular of a grip region and/or of a tool shaft (in particular to within a h6 shaft tolerance), a neck chip space, tolerances of the component, states of possibly multi-part tools (any desired tools), e.g. presence and/or correct fit of reversible plates and the like, a highest point of the tool and/or a length A dimension (in particular validated as “OK”). Collision checks (e.g. with a gripper or a shrink-fit coil) can also be carried out. If such information can now be measured or ascertained, it is also possible as a result to ascertain further data/values/information regarding the tool and/or tool holder, such as a length, how far the tool is plugged in the tool holder and whether this length is sufficient for the operation of the tool, predictions about a state of the tool, in particular tool service-life predictions. It is also conceivable to in this way orient, fix and/or mount and shrink-fit polygonal tools or tool shafts or else tools having tool shafts of any and all shapes precisely in the correct position.

All of this can then be used for validation of the tool and/or of the tool holder (with or without a tool).

Furthermore, it may also be expedient, in particular during the monitoring and/or checking of the tool receptacle, with a tool (or without a tool), and/or monitoring and/or checking of the tool, to check the tool shaft in terms of a grip region (for a gripper), a cutting-edge region, and/or in particular geometric “peculiar features” on the tool shaft.

Furthermore, it may also be expedient, in particular during the monitoring and/or checking of the tool receptacle, with a tool (or without a tool), and/or monitoring and/or checking of the tool, to comprehensively measure, check and/or validate the tool. (The same also applies, of course, as mentioned above, for the tool holder.)

Furthermore, it may also be expedient to carry out the monitoring and/or checking also upon/during the shrink-fitting operation and/or upon/during the removal operation, in particular with it being monitored or checked during the removal operation whether the tool can be removed from the tool holder.

In this case, it also seems to be particularly advantageous here if, at the same time as or during the monitoring and/or checking, corrections are made during the shrink-fitting and/or removal or mounting operation using information obtained from the monitoring and/or checking.

It is thus possible, for example, during the shrink-fitting operation to correct a length of the workpiece.

Specifically, it should again be pointed out that in particular a monitoring and/or checking of the tool and/or the tool holder (with or without a tool) can be carried out, in particular using the further measuring system and/or the further holding apparatus,
the tool receptacle, with or without a tool, can be monitored and/or checked, in particular the further measuring system being displaced substantially along the one axis (Z axis), and/or an overall length, in particular of the tool receptacle with a tool (in particular in the form of “OK” or “in tolerance”), a cutting-edge diameter, a tool shaft diameter (in particular to within a h6 shaft tolerance) and/or a length A dimension (in particular in the form of “OK”) is monitored and/or checked and/or collision checks are carried out,
the tool can be monitored and/or checked, in particular with the tool being held in and/or made to rotate by the further holding apparatus,
the tool can be monitored and/or checked, in particular with the further measuring system checking at least an uppermost point of the tool, a grip region on the tool, a tool length and/or a tool diameter or tool shaft diameter (in particular to within a h6 shaft tolerance) and/or the tool being comprehensively checked and validated and/or collision checks being carried out,
the tool receptacle can be monitored and/or checked during the shrink-fitting operation and/or during the removal operation, in particular it being monitored and/or checked during the removal operation whether the tool can be removed from the tool holder,
at the same time as or during the monitoring and/or checking, corrections can be made during the shrink-fitting and/or removal operation, in particular using information obtained from the monitoring and/or checking, and/or
during the shrink-fitting operation a length of the workpiece can be corrected.

Irrespective of the fact that the shrink-fitting apparatus is provided with respect to the clamping technique of the shrink-fitting operation, the apparatus can also be provided as an apparatus for other types of tool receptacles/chucks or clamping techniques, such as hydraulic expansion chucks, Weldon chucks, collets, face mill arbors and/or pressed-in tools and the like. What is involved here instead of the shrink-fitting unit is the correspondingly different mounting apparatus—for e.g. a hydraulic expansion chuck, a collet, etc. (see above).

In particular since also during the monitoring and/or checking of the tool receptacle, with a tool (or without a tool), and/or the monitoring and/or checking of the tool, for example in this case during the scanning, the corresponding different tool receptacles as such can be identified.

The monitoring and/or checking of the tool and/or monitoring and/or checking of the tool holder makes it possible to maximize the process reliability and procedure safety, in this case for the shrink-fitting apparatus and the method.

Furthermore, this in particular also makes it possible to increase the accuracy of the tool mounting or the mounted tool as a whole.

The efficiency and also the effectiveness of the shrink-fitting apparatus and of the method are increased.

Furthermore, it can be expedient to provide a second, further measuring device and/or a second, further holding apparatus-in particular with all the aforementioned functionalities and embodiments. If appropriate, this second, further measuring device and/or second, further holding apparatus could then replace previously existing, corresponding stations—and/or be integrated into already existing ones.

For example, such a second, further measuring device could then be provided to check finished, mounted overall tools—in particular completely (final measurement, measurement of all tool/tool holder data).

Such a second, further (comprehensive) measuring device thus then enables the complete functionality of a presetting unit—in the shrink-fitting apparatus.

Another, further independent aspect of the invention, which may also be made the subject of a divisional application, is a conveying and/or transportation box for tool holders and/or tools, as can be used or utilized in particular in the case of the shrink-fitting apparatus for the automated shrink-fitting and removal of a tool into and from a tool holder described above and in the case of the method for the automated shrink-fitting and removal of a tool into and from a tool holder described above-for transportation of tools and/or tool holders there.

The conveying box for tool holders and/or tools comprises a main body having an upper side and a multiplicity of receiving openings, which are arranged there and extend into an interior of the main body, for tool holders and tools.

Each receiving opening, arranged in the main body, for a tool holder and/or for a tool has an identical receiving opening arranged in mirror-inverted fashion on the main body.

Expressed clearly and in simplified fashion, all the receiving openings (for tools and tool holders) are twofold, one in their “original” form and one—in each case arranged in mirror-inverted fashion thereto—with or in their identical mirror image.

Mirror image can be understood to mean in this case that the respective two associated receiving openings (for a certain tool holder and/or a certain tool) are arranged symmetrically, or in mirror-inverted fashion, relative to one another about a symmetry axis/mirror axis.

This can be done very easily, for example, if the receiving openings are arranged axially symmetrically to one another.

Advantageously, the receiving openings for the tools are adapted to tool diameters and/or tool lengths. This makes it possible for the tools received in the conveying box to be received there better and more securely. This makes it easier to handle tools into and out of the conveying box.

It may furthermore also be provided that the two associated receiving openings for a tool holder, i.e. the one (“first”) receiving opening and its (“second”) identical mirror image, or its mirror-inverted receiving opening, for a tool holder are arranged overlapping one another. This achieves a saving on space combined with guaranteed structural stability/receiving reliability.

It is also advantageous—for process technology and automation technology reasons—if the receiving openings for the tools, on the one hand, and the receiving openings for the tool holders, on the other hand, are arranged in blocks and/or offset from one another in the main body.

It may furthermore be provided that the receiving openings for the tools and the tool holders, on the one hand, and their identical receiving openings arranged in mirror-inverted fashion, on the other hand, have a marker that distinguishes between them.

The marker can take any desired form, for example in terms of color and/or presentation. If thus, for example, the one receiving openings are used to deposit “new” parts, or tools or tool holders, there before the shrink-fitting operation,—and their mirror-inverted receiving openings are used to deposit used parts, or tools or tool holders, there after a shrink-fitting operation, a “good/bad” characterization (specifically referred to as a “good side” and a “bad side”) or (in color terms) green/red appears to be expedient.

This makes the handling of the conveying box considerably easier and efficient.

Lastly, it can be stated as regards the invention that it is distinguished by all of its aspects, in particular by simplicity, efficiency and effectiveness.

The description given so far of advantageous designs of the invention includes numerous features that are reproduced in the individual dependent claims, in some cases together. However, these features may expediently also be considered individually and combined into appropriate further combinations.

Even though some terms are used in each case in the singular or in combination with a numeral in the description and/or in the patent claims, the scope of the invention is not intended to be limited to the singular or the respective numeral for these terms. Furthermore, the words “a” or “an” are not to be understood as numerals, but rather as indefinite articles.

The properties, features and advantages of the invention described above and the manner in which they are achieved will become clearer and more clearly understandable in conjunction with the following description of the exemplary embodiments of the invention, which are explained in greater detail in conjunction with the drawings/figures (the same components and functions have the same designations in the drawings/figures).

The exemplary embodiments are used to explain the invention and do not restrict the invention to combinations of features, including with respect to functional features, that are specified therein. Furthermore, it is possible to this end for suitable features of each exemplary embodiment also to be considered explicitly in isolation, to be taken from one exemplary embodiment, introduced into another exemplary embodiment to supplement it and combined with any one of the claims.

### IN THE FIGURES

FIG. 1 shows a first view of a shrink-fitting apparatus for the automated shrink-fitting and removal of a tool into and from a tool holder according to one embodiment;

FIG. 2 shows a second view of the shrink-fitting apparatus for the automated shrink-fitting and removal of a tool into and from a tool holder according to the embodiment;

FIG. 3 shows a third view of the shrink-fitting apparatus for the automated shrink-fitting and removal of a tool into and from a tool holder according to the embodiment;

FIG. 4 shows a fourth view of the shrink-fitting apparatus for the automated shrink-fitting and removal of a tool into and from a tool holder according to the embodiment;

FIG. 5 shows a fifth view of the shrink-fitting apparatus for the automated shrink-fitting and removal of a tool into and from a tool holder according to the embodiment;

FIG. 6 shows a first view of the conveying box for transportation of tool holders and tools according to the embodiment;

FIG. 7 shows a second view of the conveying box for transportation of tool holders and tools according to the embodiment;

FIG. 8 shows a third view of a conveying box for transportation of tool holders and tools according to an embodiment;

FIG. 9 shows a fourth view of the conveying box for transportation of tool holders and tools according to the embodiment;

FIG. 10 shows a detail of the shrink-fitting apparatus for the automated shrink-fitting and removal of a tool into and from a tool holder according to one embodiment while a tool holder (with or without a tool) is being checked;

FIG. 11 shows a detail of the shrink-fitting apparatus for the automated shrink-fitting and removal of a tool into and from a tool holder according to one embodiment while a tool holder (with or without a tool) is being checked;

FIG. 12 shows a detail of the shrink-fitting apparatus for the automated shrink-fitting and removal of a tool into and from a tool holder according to one embodiment while a tool (which is to undergo shrink-fitting) is being checked;

FIG. 13 shows a detail of the shrink-fitting apparatus for the automated shrink-fitting and removal of a tool into and from a tool holder according to one embodiment while a tool (which is to undergo shrink-fitting) is being checked;

FIG. 14 shows a detail of the shrink-fitting apparatus for the automated shrink-fitting and removal of a tool into and from a tool holder according to one embodiment while a check is being carried out during the shrink-fitting and/or removal operation;

FIG. 15 is a (perspective) illustration of an induction coil arrangement with exchangeable stop disk in the shrink-fitting apparatus for automated shrink-fitting and removal according to one embodiment;

FIG. 16 is an illustration (from above) of an induction coil arrangement with exchangeable stop disk in the shrink-fitting apparatus for automated shrink-fitting and removal according to one embodiment;

FIG. 17 is an illustration (from the front) of an induction coil arrangement with exchangeable stop disk in the shrink-fitting apparatus for automated shrink-fitting and removal according to one embodiment;

FIG. 18 is an illustration (from the rear) of an induction coil arrangement with exchangeable stop disk in the shrink-fitting apparatus for automated shrink-fitting and removal according to one embodiment;

FIG. 19 is an illustration (in section) of an induction coil arrangement with exchangeable stop disk in the shrink-fitting apparatus for automated shrink-fitting and removal according to one embodiment;

FIG. 20 shows a view of a shrink-fitting apparatus for the automated shrink-fitting and removal of a tool into and from a tool holder having an ultrasonic cleaning facility (for tools and/or tool holders) according to one embodiment.

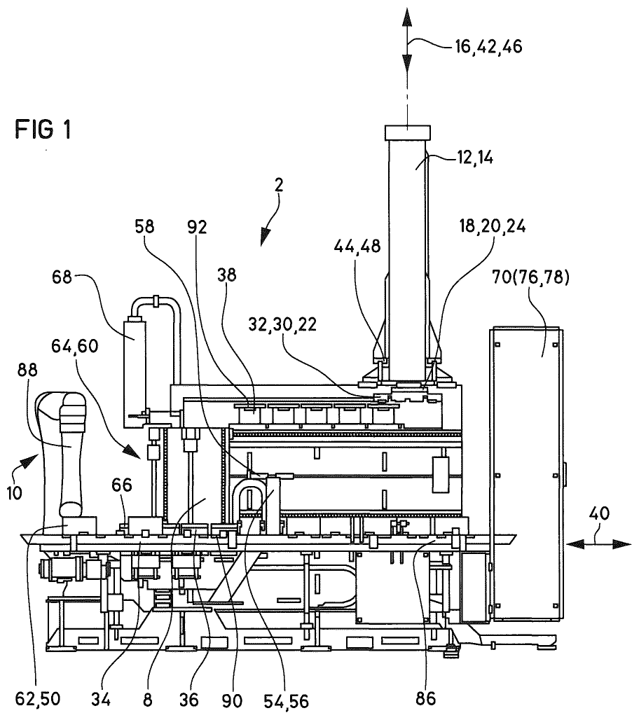

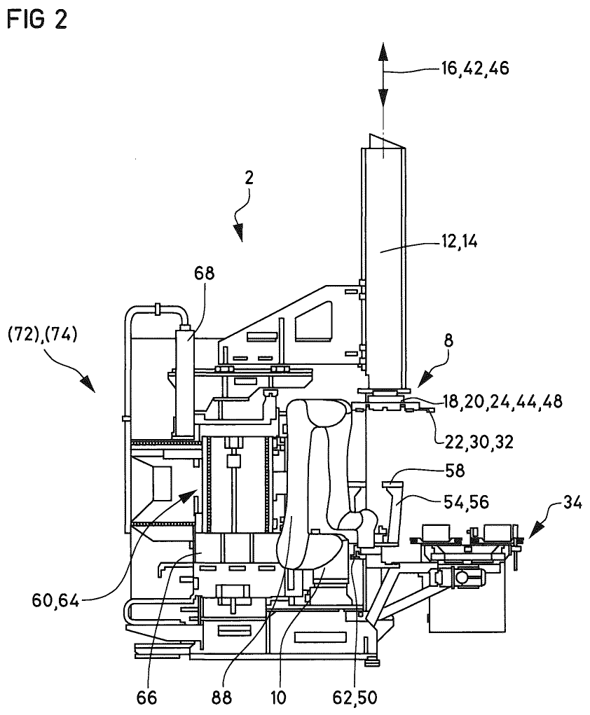

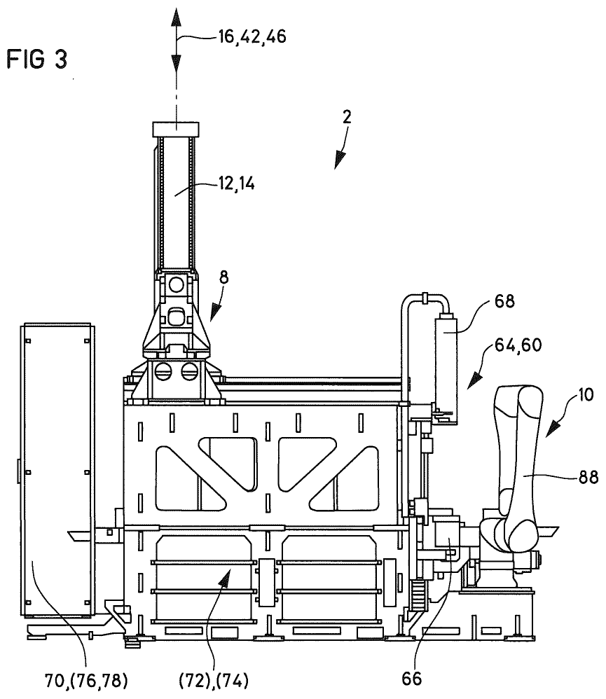

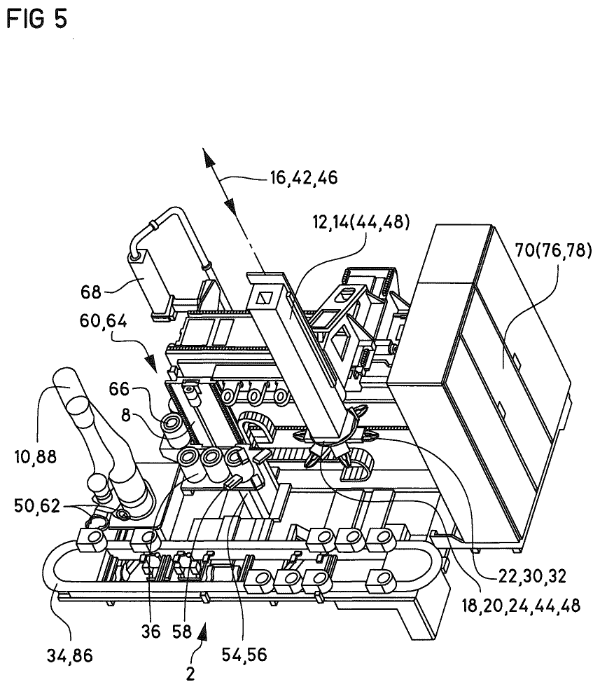

### AUTOMATED SHRINK-FITTING CELL 2, OR SHRINK-FITTING APPARATUS 2, FOR THE AUTOMATED SHRINK-FITTING AND REMOVAL OF A TOOL INTO AND FROM A TOOL HOLDER (FIGS. 1 TO 5 AND FIGS. 10 TO 14)

FIGS. 1 to 5 show—in various views and details—a shrink-fitting apparatus 2 for the automated shrink-fitting and removal of a tool 4 into and from a tool holder 6—in short referred to as automated shrink-fitting cell 2, or just shrink-fitting cell 2. FIGS. 10 to 14 show—details of—checks being made on the tool 4 and/or the tool holder 6 in the shrink-fitting apparatus 2.

### (A) The Facility/the Shrink-Fitting Cell 2

As shown in FIGS. 1 to 5, the—compactly structured—shrink-fitting cell 2 provides, as essential components, a conveyor belt 34, a multiaxial industrial robot/gripper arm 10, a centering station 54, an (inductive) shrink-fitting unit 8, a cooling station 64 and switching cabinets 70 and a control computer 76, and also a safety screen 80—, which in the form illustrated (in FIGS. 1 to 5) are arranged with a compact structure—and functionally interact in an integrated overall process of loading a tool holder 6 with tools 4 (in the course of automated industrial manufacturing).

### Conveyor Device 34

In functional terms, the “constituent part, or component, that establishes” the facility, or the shrink-fitting cell 2, is a conveyor device 34, which, as shown in FIGS. 1 to 5, is in the form of an encircling, segmented conveyor belt 34.

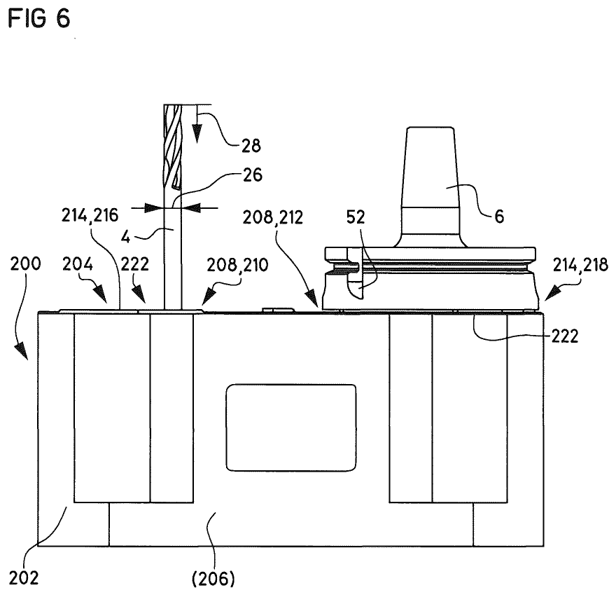

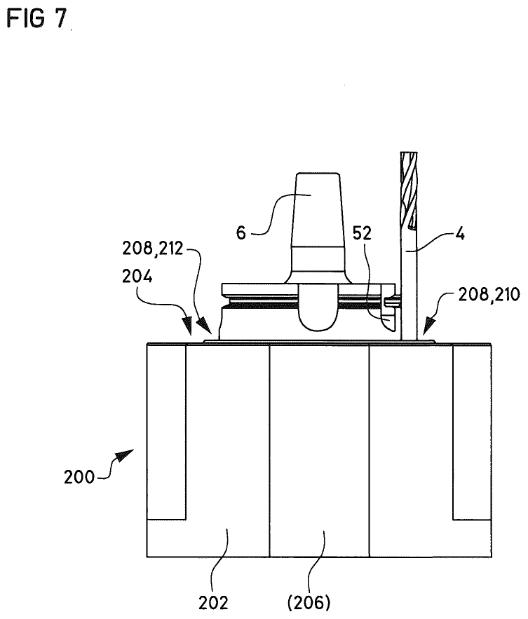

The individual segments 86 of the conveyor belt 34 are in turn designed such that they can each be loaded with a conveying box 200 (which for its part can in turn be loaded with tools 4 and tool holders 6) (see below with respect to FIGS. 6 to 9).

### Multiaxial Industrial Robot/Gripper Arm 10

Furthermore, as FIGS. 1 to 5 show, the shrink-fitting cell 2 provides a multiaxial articulated-arm robot 10 (first multiaxial handling apparatus 10), which is positioned at the side of the conveyor belt 34.

The articulated/gripper arm 88 of this multiaxial articulated-arm robot 10 is designed with a double gripper 62—for gripping a tool 4 (first gripper) on one side and for gripping a tool holder 6 (second gripper) on the other side.

The position (see FIGS. 1 to 5) of the multiaxial articulated-arm robot 10 and its arm geometry is provided such that the essential regions of the shrink-fitting cell 2 can be reached by the multiaxial articulated-arm robot 10, or its double gripper 62.

### (Inductive) Shrink-Fitting Unit 8 With Gripper Tower 12

The shrink-fitting unit 8, which (in geometric and also functional terms) forms a central constituent part of the shrink-fitting cell 2, comprises, as FIGS. 1 to 5 show, various (clamping) spindles 36, in short just spindles 36, which are arranged next to one another and by means of which tool holders 6 can be held in position in clamped fashion during the shrink-fitting operation. The spindles 36 are in this case also rotatable about a vertical axis—here and below referred to as Z axis 16.

The spindles 36, for their part, are arranged on a horizontally 40 and vertically 42 (Z axis 16) displaceable stage 90, as a result of which they can be displaced or lifted in the stated directions.

In the case of the first handling apparatus 10, also arranged in the region of the double gripper 62 is a reading device 50, in this case an optical reading device 50, which can be used to read markings 52 (cf. FIGS. 6, 7 and 9), such as in particular tool holder codes 52, which can be applied to a tool holder 6—, in particular when a tool holder 6 clamped in one of the spindles 36 is rotated by means of the spindle 36 that clamps it.

The shrink-fitting unit 8 also provides multiple induction coil arrangements 38, which are also arranged next to one another and are arranged at predefined vertical 42 spacings (Z axis 16 spacings) above the spindles 36—and which are also aligned with respect to the stated Z axis 16. The induction coil arrangements 38 also have—if relevant here—the usual stop disks 92 (concentrators/ferrite disks).

If, as illustrated here, the induction coil arrangements 38 are also arranged at fixed heights, it may also be provided that they are arranged vertically displaceably—along the Z axis 16.

The displaceability of the stage 90 bearing the spindles 36 is set up such that—on the one hand each of the spindles 36 can be moved underneath each induction coil arrangement 38 in the continuation of the Z axis 16—and on the other hand each spindle 36 can be lifted up to each induction coil arrangement along the Z axis 16.

Furthermore also provided here are means 44, 48, which can be used to monitor the vertical 42 lifting travel 46 of the spindles 36 and a collision with the induction coil arrangements 38, in particular with the stop disks 92 of the induction coil arrangement 38.

Furthermore, the shrink-fitting unit 2 has the aforementioned multiple spindles 36 and induction coil arrangements 38 installed—in this case shown, three spindles 36 and five induction coil arrangements 38, in order to thus also be able to shrink-fit an overall pallet of tools 4 and tool holders 6 if this plurality of spindles 36 and induction coil arrangements 38 have different geometric dimensions.

The shrink-fitting unit 2 also provides, as shown in FIGS. 1 to 5, a handling apparatus 12 (second, automatically displaceable handling apparatus 12)—here in short referred to as simply gripper tower 12 below—which is automatically displaceable along the Z axis 16 by means of a linear drive 14.

The gripper tower 12 can be displaced—irrespective of its linear displaceability along the Z axis 16 and independently thereof—also by itself—automatically horizontally 40—to a predefinable extent.

The gripper tower 12 provides, as shown in FIGS. 1 to 5, a gripper head 18 rotatable about the Z axis 16. The rotational position of the gripper head 18 can be determined by means of an angle measuring apparatus 20 and thus its positioning can be monitored.

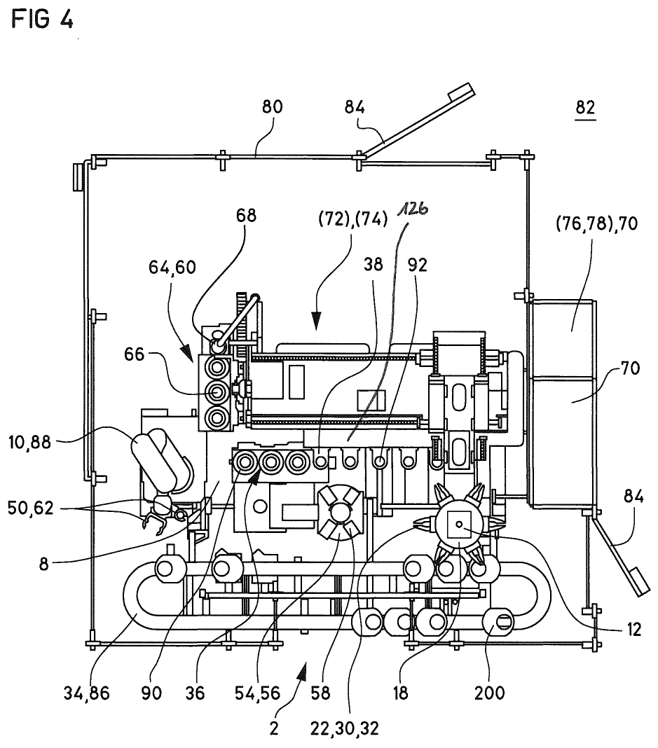

The gripper head 18 for its part has multiple gripper apparatuses 22 (pincer grippers 22) for gripping of tools 4. As shown in particular in FIG. 4, the multiple gripper apparatuses 22, in this case six, are arranged on the gripper head 18 evenly distributed about the Z axis 16.

Furthermore, the gripper head 18 is equipped with force measuring devices 24, which can be used to measure a tensile and/or shear force exerted by the gripper head 18 or the gripper apparatus 22 on a tool 4, in order thus to be able to monitor the introduction of a tool 4 into a tool holder 6, or the withdrawal of a tool 4 from a tool holder 6 (here, the gripper tower 12 or the gripper head 18 is displaced along the Z axis 16).

Furthermore, such a (or each) gripper device 22 is equipped with two gripper jaws 30 which during the gripping operation can be moved relative to one another and electromotively displaced. In this case, the electromotive displacement of the gripper jaws 30 makes it possible to measure and monitor a gripping operation, in particular in terms of a gripping force.

Each gripper jaw 30 provides a stop lug 32 which can serve as stop element during positioning (along the Z axis 16). The gripper jaws 30 for their part are also arranged exchangeably—and positionally accurately clampably in the gripping apparatus 22.

In order to be able to grip an entire pallet of tools 4 of various dimensions, the gripper apparatuses 22 are adapted to tools 4 of predefinable diameters 26.

### Centering Station 54 With Alignment Control or Alignment Control Device 58 (Measuring Laser 58)

As FIGS. 1 to 5 also show, the shrink-fitting cell 2 also provides a centering station 54—arranged in the region between the conveyor device 34 and the shrink-fitting unit 8—for clamping and aligning a tool 4.

The centering station 54 has—in this case shown here—three symmetrically arranged clamping jaws 56, which can be used to hold a tool 4 in centered (and) clamped fashion.

Furthermore, provided on the centering station 54—above the clamping jaws 56—is an alignment control device 58, for example in the form of a laser-based measuring system 58 (measuring laser), which can be used to determine and monitor an alignment, in particular with respect to the Z axis 16, of a tool 4 removed from the centering station 54 by means of the gripper tower 12.

This alignment control device 58, or the laser-based measuring system 58, is intended to also make it possible to measure the geometry of a tool 4.

### Cooling Station 64

On the left-hand side next to the shrink-fitting unit 8 there is, in the shrink-fitting cell 2, a cooling station 64 for cooling of tool holders 6 heated by the shrink-fitting operation, as will be described essentially in the laid-open specification for the application which has the official file reference DE 10 2022 114 046.6.

The cooling station 64—as installed here according to FIGS. 1 to 5—has—similarly to the shrink-fitting unit 8—multiple (clamping) spindles 66, in short also just spindles 66, in this case three spindles 66, which are arranged next to one another and can be used to hold (and possibly, as required, rotate) tool holders 6 in clamped fashion during the cooling operation.

Furthermore, the cooling station 64 provides a cooling attachment 68, which can be fitted over tool holders 6 held on the spindles 66 and which is designed to generate an eddy-current cooling (cyclone cooling) effect.

Such a cooling attachment 68 is described for example in the cited laid-open specification for the application which has the official file reference DE 10 2022 114 046.6.

### Balancing Apparatus 72 and Presetting Device 74

Furthermore, it is then also possible to arrange a balancing apparatus 72 and possibly also a presetting device 74 (not illustrated) in the back of the shrink-fitting unit 8.

The balancing apparatus 72 and the presetting device 74 may be designed as usual (as known from the prior art) for the sake of simplicity.

This would make it possible to balance and measure “freshly shrink-fitted” tool holders 6 (also “in the same way”).

### Switching Cabinets 70 and Control Computer 76

On the right-hand side next to the shrink-fitting unit 8 there is, in the shrink-fitting cell 2, as FIGS. 1 to 5 show, switching cabinets 70 and a control computer 76 (with monitor, input means and printer) (not shown), in which the (control) electronics/electrical system (if it is not installed directly in the constituent parts/components) or the controller 78 (software 78) for the shrink-fitting cell 2 are received or stored.

The shrink-fitting cell 2 can be operated and/or controlled via the control computer 76.

### Safety Screen 80/Safety Fence 80

To protect the shrink-fitting cell 2, it provides a safety screen 80—in this case in the form of a safety fence 80, which can be used to screen wide regions of the shrink-fitting cell 2 from an area 82 surrounding (around) the shrink-fitting cell 2.

As in particular FIG. 4 shows, this safety screen 80, or this safety fence 80, has two (possibly automatically lockable/unlockable) doors 84, which allow entry to regions of the shrink-fitting cell 2.

The safety screen 80, or safety fence 80, also leaves a “middle” region of the conveyor belt 34 unscreened, such that in this case it is possible to load the conveyor belt 34 (manually and also in automated fashion), for example with the conveying boxes 200 (see below).

All the components of the shrink-fitting cell 2 are connected to one another by means of wiring (not illustrated in more detail), so that data, such as control commands and geometry data (for tools 4 and tool holders 6) can be transmitted thereto or be present there.

### (B) The Process

During the automated shrink-fitting and/or removal of tools 4 into and/or from tool holders 6 in the shrink-fitting cell 2 described above, the following process is executed:
(a) loading a conveying box 200, arranged on the conveyor device 34, with a tool 4 (to undergo shrink-fitting) and a tool holder 6 having a tool 4 (to be removed),
(b) transporting the conveying box 200, loaded with the tool 4 (to undergo shrink-fitting) and the tool holder 6 having the tool 4 (to be removed), by means of the conveyor device 34 to the shrink-fitting unit 8, or to a vicinity of one of the (clamping) spindles 36 of the shrink-fitting unit 8 there,
(c) transferring the tool holder 6 with the tool 4 (to be removed) (in short always just tool holder 6 below for the sake of clarity) from the conveying box 200 to the or one of the spindles 36 of the shrink-fitting unit 8 using the multiaxial articulated-arm robot 10,
(d) clamping the tool holder 6 on the spindle 36 of the shrink-fitting unit 8,
(e) rotating the tool holder 6 clamped on the spindle 36 of the shrink-fitting unit 8 about the Z axis 16 and using the reading device 50 to read a marker 52, or tool holder code 52, applied to the tool holder 6,
(f) providing tool holder, tool and shrink-fit data or parameters, in particular using the marker 52, or tool holder code 52, applied to the tool holder 6 and read,
(g) transferring the tool 4 (to undergo shrink-fitting) from the conveying box 200 to the centering station 54 by means of the multiaxial articulated-arm robot 10,
(h) clamping and aligning the tool 4 (to undergo shrink-fitting) in the centering station 54,
(i) gripping the tool 4 (to undergo shrink-fitting), which is clamped in the centering station 54, by means of the gripper tower 12, or gripper apparatus 22 (pincer gripper 22) there, such that the tool 4 (to undergo shrink-fitting) after the shrink-fitting operation into a tool holder 6 has a predefinable position in the tool holder 6,
(j) measuring the tool 4 (to undergo shrink-fitting), gripped by the gripper tower 12, by means of the measuring system 58 and measuring the alignment of the tool 4 (to undergo shrink-fitting) in terms of the Z axis 16—and also possibly its geometry (for example length),
(k) displacing the tool holder 6 clamped on the spindle 36 of the shrink-fitting unit 8—to underneath the induction coil arrangement 38 (provided for the actual shrink-fitting operation) of the shrink-fitting unit 8 in the continuation of the Z axis 16,
(l) ascertaining the lifting travel 46 of the tool holder 6 clamped on the spindle 36 of the shrink-fitting unit 8 along the Z axis 16—possibly also using the geometry of the tool holder 6,
(m) lifting the tool holder 6 clamped on the spindle 36 of the shrink-fitting unit 8 along the Z axis 16 until the tool holder 6 comes into abutment with the stop disk 92 of the induction coil arrangement 38,
(n) (in the process) monitoring the lifting operation 46 of the tool holder 6 clamped on the spindle 36 of the shrink-fitting unit 8 in terms of the lifting travel 46 (cf. lifting travel monitoring device 44) and a collision with the induction coil arrangement 38 or with stop disks 92 of the induction coil arrangement 38 (cf. collision monitoring apparatus 48),

(Removing the “old/used” tool 4 from the tool holder 6 and shrink-fitting a new tool 4 into the tool holder 6)
(o) heating the tool holder 6 using the induction coil arrangement 38 of the shrink-fitting unit 8,
(p) gripping the tool 4 (to be removed), which is arranged in the tool holder 6, by way of the gripper tower 12 or gripper apparatus 22 (pincer gripper 22) and displacing the tool 4 (to be removed), that is gripped by the gripper tower 12 or gripper apparatus/pincer gripper 22, along the Z axis 16 out of the tool holder 6—while monitoring the displacement of the gripped tool 4 in terms of a tensile force exerted on the tool (to be removed) (cf. force measuring device 24),
(q) pivoting, or rotating, the gripper head of the gripper tower (cf. angle measuring apparatus 20),
(r) displacing (inserting) the tool 4 (to undergo shrink-fitting), that is gripped by the gripper tower 12, along the Z axis 16 relative to the tool holder 6 into a predefinable shrink-fit position with respect to the tool holder 6 until the stop lugs 32 of the gripper apparatus 22 of the gripper head 18 rest on the upper end face of the tool holder 6 (or on the stop disk 92 of the induction coil arrangement 38) while monitoring the displacement of the gripped tool 4 in terms of a shear force exerted on the tool (to undergo shrink-fitting) (cf. force measuring device 24),
(s) temporarily holding the tool 4 (to undergo shrink-fitting into the tool holder 6) by means of the gripper tower 12 at least until the tool 4 (to undergo shrink-fitting) is clamped by means of cooling the tool holder 6,
(t) lowering the tool holder 6, that is clamped on the spindle 36 of the shrink-fitting unit 8 (and clamps the tool 4 which has newly just undergone shrink-fitting), along the Z axis 16,
(u) transferring the tool holder 6, that is clamped on the spindle 36 of the shrink-fitting unit 8 (and clamps a tool 4 which has newly just undergone shrink-fitting), to the cooling station 64 using the multiaxial articulated-arm robot 10—and clamping the tool holder 6 there on one of the spindles 66,
(v) cooling the tool holder 6 (that clamps the tool 4 which has newly just undergone shrink-fitting) using the eddy-current cooling (cyclone cooling) from the cooling attachment 68,
(w) measuring the tool holder 6 (that clamps the tool 4 which has newly just undergone shrink-fitting) in the cooling station (cf. measuring laser 60),
(x) displacing the (just removed) tool 4 to the conveying box 200 by means of the gripper tower 12 and loading the conveying box 200 therewith or displacing the (already removed) tool 4 to the centering station 54 by means of the gripper tower 12 (and optionally transferring the tool 4 from there to the conveying box 200),
(y) transferring the (cooled) tool holder 6 to the conveying box 200 by means of the multiaxial articulated-arm robot 10,
(z) transporting the loaded conveying box 200 away by means of the conveyor belt 34.

### Checks of the Tool 4 and/or the Tool Holder 6 in the Shrink-Fitting Apparatus 2 (FIGS. 10 to 14)

For these checks, the shrink-fitting apparatus 2, as FIGS. 10 to 14 show, provides a highly accurate measuring system 94, in this case a transmitted-light measuring system 94, which can be displaced along the Z axis and also transversely thereto in the shrink-fitting apparatus 2.

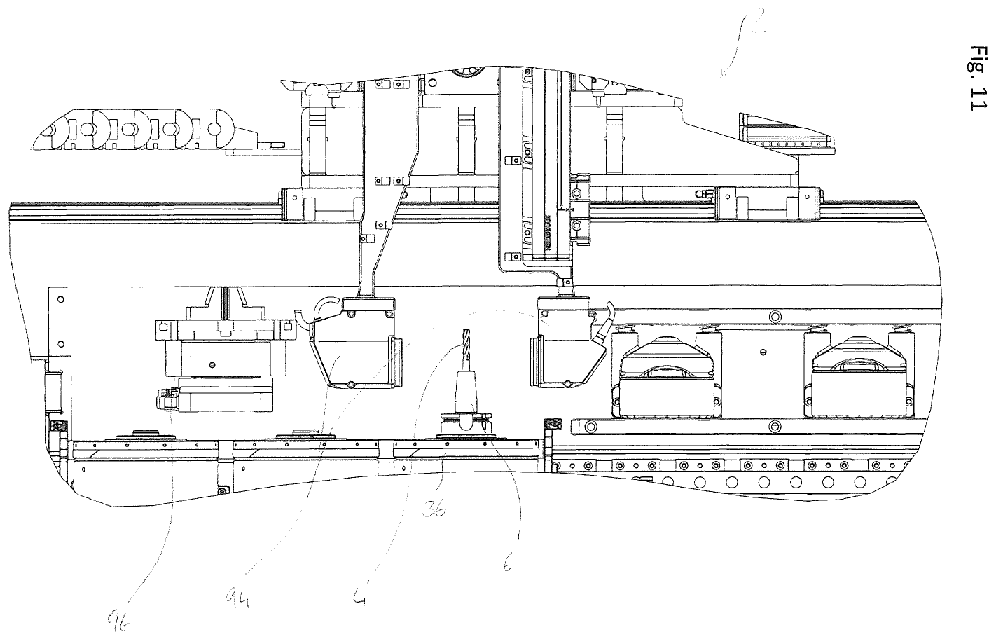

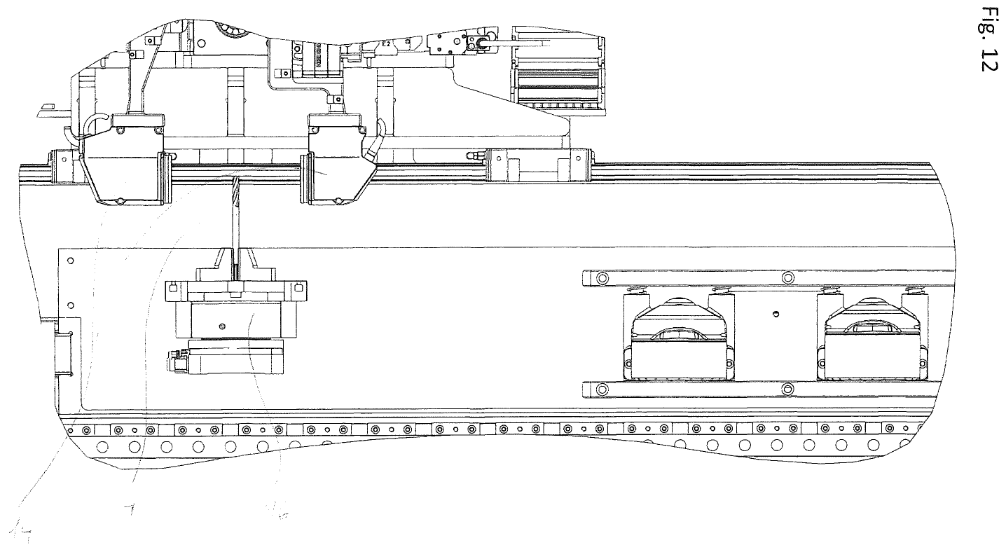

The shrink-fitting apparatus, as FIGS. 12 to 13 show, also has-in addition to the spindles 36 described above-a rotatable jaw chuck 96, which is (also) provided to clamp tools (in this case while they are being checked) (cf. FIGS. 12 and 13)—and which jaw chuck 96 can also be displaced transversely to the Z axis.

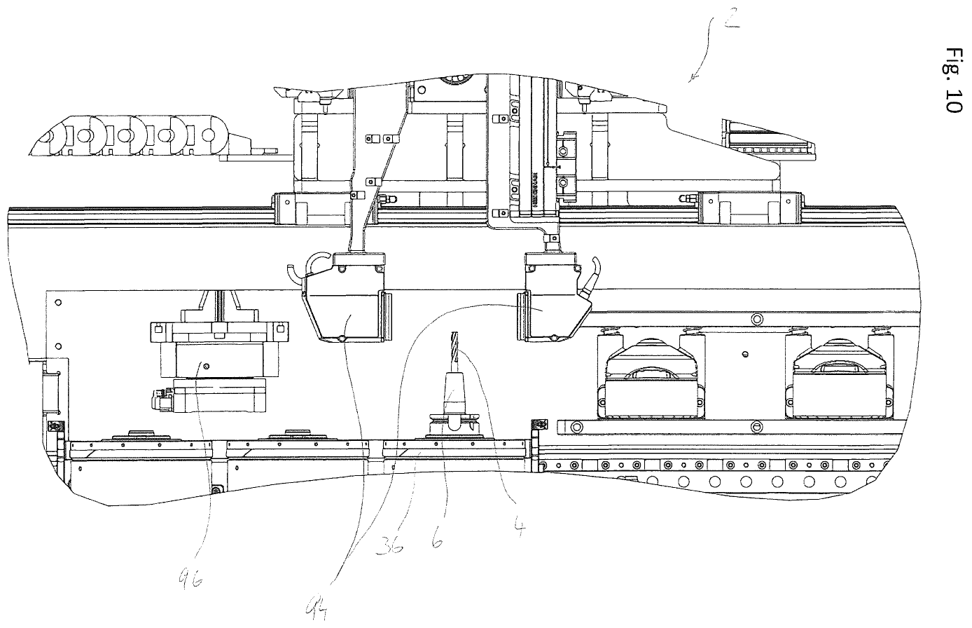

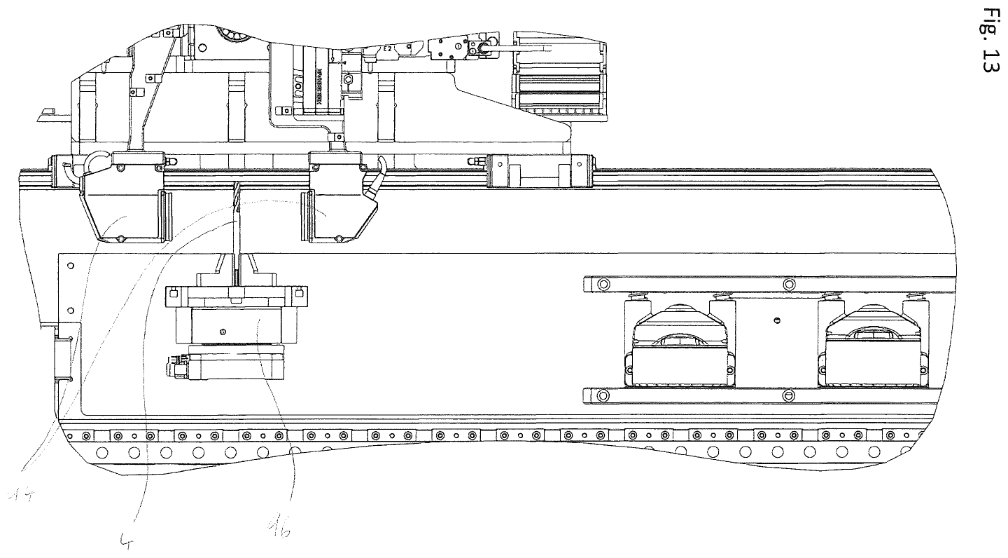

The measuring system 94 carries out three important checks/validations on the tool receptacle 6 or on the tool 4:
(1) checking and validation of a tool holder 6 (with or without tools 4, and into which the tool 4 is to be shrink-fitted) (FIGS. 10 and 11),
(2) checking and validation of a tool 4, which is to be shrink-fitted (FIGS. 12 and 13),
(3) checking and (simultaneous) correction during the shrink-fitting and during the removal of the tool 4 (FIG. 14).

Integrating the measuring system 94 in the shrink-fitting apparatus and in the automated tool exchange in the shrink-fitting apparatus 2 makes it possible to maximize the process reliability and procedure safety and also the accuracy of the tool exchange.

### (1) Checking and Validation of a Tool Holder 6 (With or Without a Tool 4) (FIGS. 10 and 11).

FIG. 10 shows a detail of the shrink-fitting apparatus 2 while a tool holder 6 (with or without a tool 4—illustrated here with a tool 4) is being checked (in a first (upper) measurement position).

Here, according to FIG. 10, the measuring apparatus 94 is positioned—above—relative to the tool holder 6 (with a clamped-in tool 4 that is to be removed), which tool holder 6 is held in the spindle 36, such that at least the highest point of the tool 4 projects into the measurement region of the measuring system 94.

While the check is being performed, the measuring system 94 is then displaced vertically downward along the Z axis (see FIG. 11—second (middle) measurement position), such that the measurement region of the measuring system 94 sweeps over the tool holder 6 (with a tool 4) from top to bottom—and the tool holder 6 (with clamped-in tool 4) is thus measured (scanned)—and can subsequently be validated—as a whole.

Here, the tool holder 6 (with a tool 4) is measured or checked, among other things, with respect to:
overall length (of the tool holder with a tool) OK, or in tolerance
cutting-edge diameter
state of the cutting edges
cleanliness, (adherent) dirt, e.g. chips
coatings (color) and/or surface states
states of possibly multi-part tools, e.g. correct fit of reversible plates
cutting-edge region and grip region
cylindricity of the grip region or shaft region (h6 tolerance)
tool holder—length A dimension OK
plug-in depth of the tool 4 in the tool holder 6 (in conjunction with information about the overall length of the tool)
projecting length
shaft length
in the case of tool receptacles with screw clamping means (Weldon, hydraulic expansion, etc.), ascertaining the socket width
collisions (collision check e.g. gripper, shrink-fit coil)
correct tool holder 6/correct tool 4
grip region OK

The measurement can then be taken as a basis to validate the tool holder 6 (with a tool 4).

If there is a tool holder 6—without a clamped-in tool 4—during the checking, this (i.e. the missing tool 4) can also be detected and/or identified during the 8 measurement.

### (2) Checking and Validation of a Tool 4 (, Which is to be Shrink-Fitted) (FIGS. 12 and 13)

FIG. 12 shows a detail of the shrink-fitting apparatus 2 during the checking and validation of the tool 4 (, which is to undergo shrink-fitting) (in a first (upper) measurement position).

Here, according to FIG. 12, the measuring apparatus 94 is positioned—above—relative to the tool 4, such that at least the highest point of the tool 4 projects into the measurement region of the measuring system 94.

While the check is being performed, the measuring system 94 is then displaced vertically downward along the Z axis (see FIG. 13—second (middle) measurement position), such that the measurement region of the measuring system 94 sweeps over the tool 4 from top to bottom—and the tool 4 is thus 11 measured (scanned)—and can subsequently be validated—as a whole.

For this, as FIGS. 12 and 13 also show, the tool 4 is clamped in a rotatable jaw chuck 96—and the measuring system 94 checks—according to FIG. 12—the uppermost point of the tool 4—and after that—according to FIG. 13—the region where a gripper takes up the tool 4 for the shrink-fitting operation. In an advantageous embodiment, the jaw chuck 96 is configured such that that part of the tool 4 that is clamped in the jaw chuck 96 can also still be detected and checked, or measured, by the measuring system 94.

In the process, the tool 4 can be comprehensively checked and validated by rotating the jaw chuck 94.

It is therefore possible to measure or check, among other things:
tool length,
tool diameter,
tool shaft diameter,
cylindricity of the tool shaft (h6 tolerance)
presence of clamping faces on the tool shaft (e.g. Weldon clamping faces)
state of the cutting edges
cleanliness, (adherent) dirt, e.g. chips
coatings (color) and/or surface states
states of possibly multi-part tools, e.g. correct fit of reversible plates—cutting—edge region/grip region
neck chip space
collisions (collision check e.g. gripper)
grip region OK

### (3) Checking and (Simultaneous) Correction During the Shrink-Fitting and During the Removal of the Tool 4 (FIG. 14)

FIG. 14 shows a detail of the shrink-fitting apparatus 2 during checking and (simultaneous) correction during the shrink-fitting and/or removal of the tool 4 (in a measurement position).

Here, according to FIG. 14, the measuring apparatus 94 is positioned—above—relative to the tool 4, such that at least the highest point of the tool 4 projects into the measurement region of the measuring system 94—and thus can be measured “live”.

Thus, by means of this measuring system 94, the process is monitored during the shrink-fitting operation and removal operation as follows:
during the shrink-fitting operation, the length of the overall tool is simultaneously corrected, since the highest point can be corrected “live” by the controller of the shrink-fitting apparatus 2;
during the removal operation, monitoring is performed as to whether the tool 4 can be removed from the tool holder 6,-and in the process it is possible to prevent the gripper from slipping into collision regions if problems arise during the removal operation. For this, a comparison is made as to whether the extraction movement of the gripper matches the actual movement of the tool.

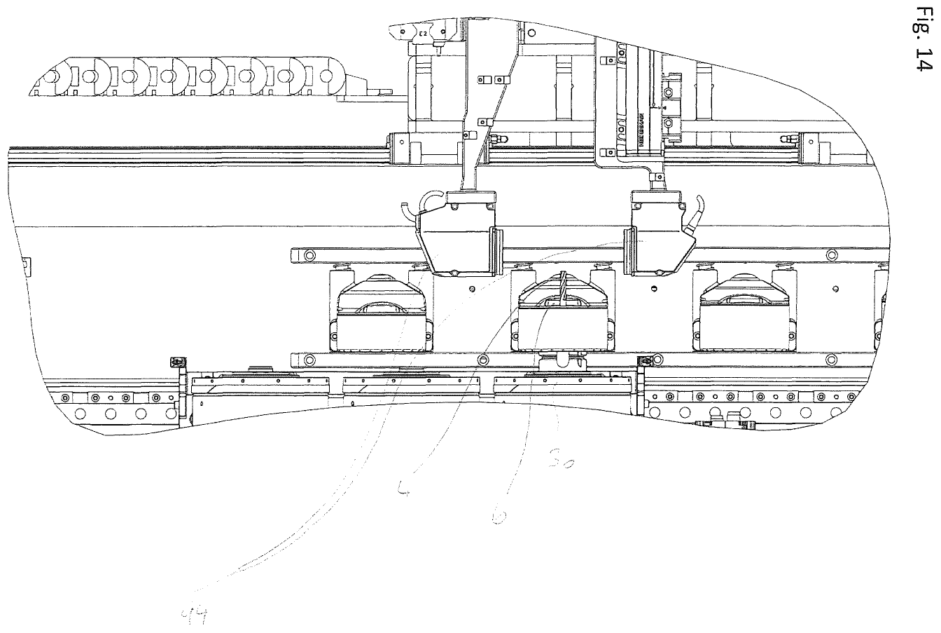

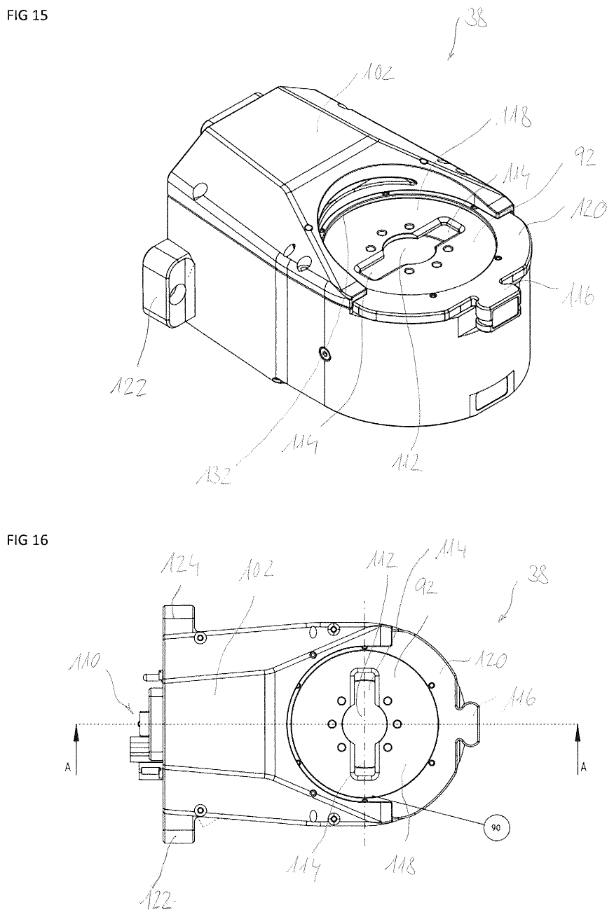

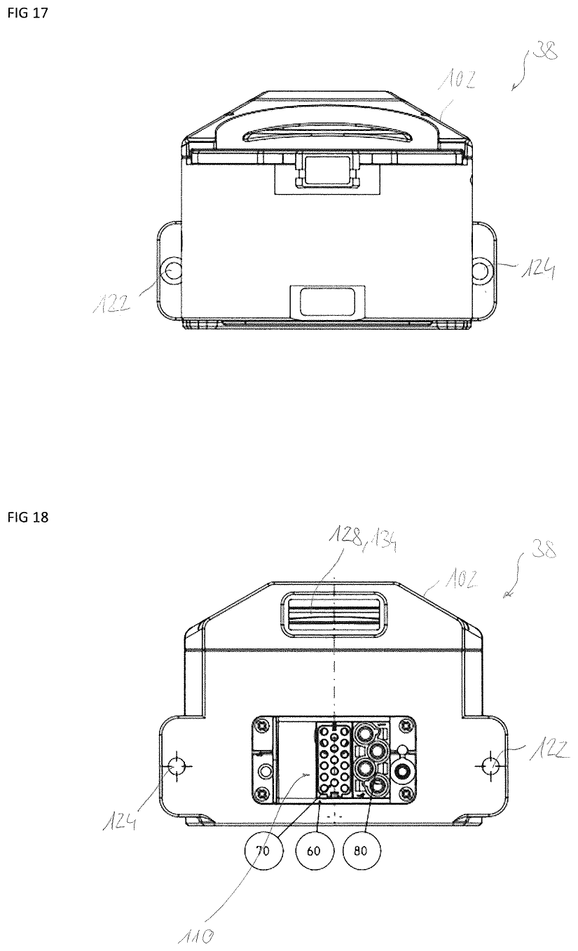

### Induction Coil Arrangement 38 With Exchangeable Stop Disk 92 (FIGS. 15 to 19)

FIGS. 15 to 19 show—various views of—one of the induction coil arrangements 38 present in the shrink-fitting cell 2.

As already mentioned, the shrink-fitting unit 2 can be used to shrink-fit an overall pallet of tools 4 and tool holders 6 which differ in their geometric dimensions, such as tool and tool-holder diameters.

In order to enable this variability or flexibility, installed in the shrink-fitting unit 2 are multiple, in this case five, induction coil arrangements 38, which differ among other things in their winding bodies 104, in particular winding-body heights and diameters, in order to thereby be able to shrink-fit (geometrically) different tool holders 6, which differ in particular in the length of the region to be heated.

Furthermore, this variability or flexibility is enabled in that the various induction coil arrangements 38 each have an exchangeable or interchangeable stop disk 92, the configuration of which is adapted to various tools 4 or their tool diameters.

If the induction coil arrangements 38 and the stop disks 92 are each encoded by means of a readable code corresponding to their assignment for the shrink-fitting (see above regarding the variability or flexibility), it is possible, for the shrink-fitting of a specific tool 4 or tool holder 6, to select and “compose” the correct combination of induction coil arrangement 38 and stop disk 92 (for this specific tool 4 or specific tool holder 6)—and thus use this combination in the process.

FIGS. 15 to 19 show—in various views—(by way of example) such an induction coil arrangement 38—with exchangeable stop disk 92.

As FIGS. 15 to 19 show, the induction coil arrangement 38 provides a coil housing 102, inside which the annularly wound winding body 104 is received.

On its rear end, in the coil housing 102, various plug-in connections and connecting elements 110 are mounted, which—if the coil housing is screwed to its support 126 via the left-hand and right-hand screwed connection 122, 124 (cf. FIG. 4)—are connected by a plug fit to complementary plug-in connections/connecting elements 110 there, whereby power can be supplied to the electrical system/electronics of the induction coil arrangement 38.

A further important constituent part of the induction coil arrangement 38 is the aforementioned stop disk 92, which can be slid into a guide-forming slot 132 there on its top side. Latching elements (not shown) in the slot 132 make it possible to latch the completely slid-in stop disk 92 in place.

The stop disk 92 consists of a disk-shaped disk element or ferrite body 118, which is received in an aluminum mount 120.

In the middle of the ferrite disk 118 there is a circular through-opening 112, the diameter of which is adapted to tools 4 that are to undergo shrink-fitting into the tool holder 6, or in turn to their diameter (—and thus is different for all ferrite disks—see above). Furthermore provided opposite the circular through-opening 112 of the ferrite disk 118 are clearances 114, which allow the pincer gripper 22 to insert the tool 4, that it grips and that is to undergo shrink-fitting, through the through-opening 112 into the tool holder 6 or (during the removal operation) to grip the respective tool to be removed and take it out of the tool holder 6.

Arranged on the front edge of the mount 120 of the stop disk 92 is a grip element 116, which serves for the stop disk 92 to be able to be gripped by one of the pincer grippers 22—while it is being exchanged. That is to say, it is predetermined for at least one of the multiple gripper apparatuses 22/pincer grippers 22 of the gripper head 18 to grip it or exchange the stop disk.

On the upper side of the induction coil arrangement 38 there is the aforementioned, virtually semicircular, forwardly open slot 132, in which the stop disk 92 can be slid—from front to rear. The stop disk 92, which is virtually round per se, or its mount 120 is flattened on both sides; correspondingly, the slot 132 runs out in a straight line at its front ends on both sides, as a result of which the stop disk 92 can thus only be slid in in a defined way or is correspondingly aligned in its correct position when being slid in.

Two mechanical contact switches 106, 108—one at the front, one at the rear on the contact edge of the stop disk 92 or its mount 120 on the coil housing 102 are used to monitor the slid-in state of the stop disk 92, or its position. These contact switches 106, 108 in particular identify whether the stop disk has been slid in or positioned correctly or completely.

The winding body 104 in the coil housing 102 is cooled by compressed-air cooling to the extent that compressed air is blown over the support 126 into the coil housing in the region of the connecting/plug-in elements 110.

To cool the tool 4 or tool 6 received in the induction coil arrangement 38 or in the winding body 104 (after the shrink-fitting operation), an annular duct 136 is provided in the winding body 104, which is inwardly connected to the opening receiving the tool 4 and the tool holder 6 via—in this case six—evenly distributed openings 138. The annular duct 136 is supplied with compressed air/cooling air from the outside via a pressure line (not illustrated) and a connection 140 emerging into the annular duct 136. Via this 136 and the openings 138, the compressed air can then be blown onto the tool 4/tool holder 6.

Other cooling media (than compressed air) can correspondingly be used in the case of the induction coil arrangement 38.

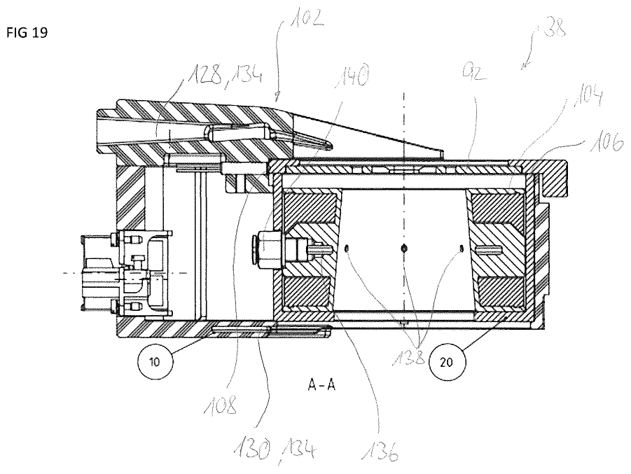

Vapors and/or gases produced during the shrink-fitting operation are extracted via a fume extraction means 134 in the case of the induction coil arrangement 38. For this, as FIGS. 18 and 19 show, the coil housing 102 in its upper region provides an (upper) fume extraction duct 128 or in its lower region provides a (lower) fume extraction duct 130, via which vapors/gases escaping upward or vapors gases escaping downward can be extracted.

Stop disks 92 to be exchanged are stored in an exchange store (not illustrated) in the shrink-fitting cell 2.

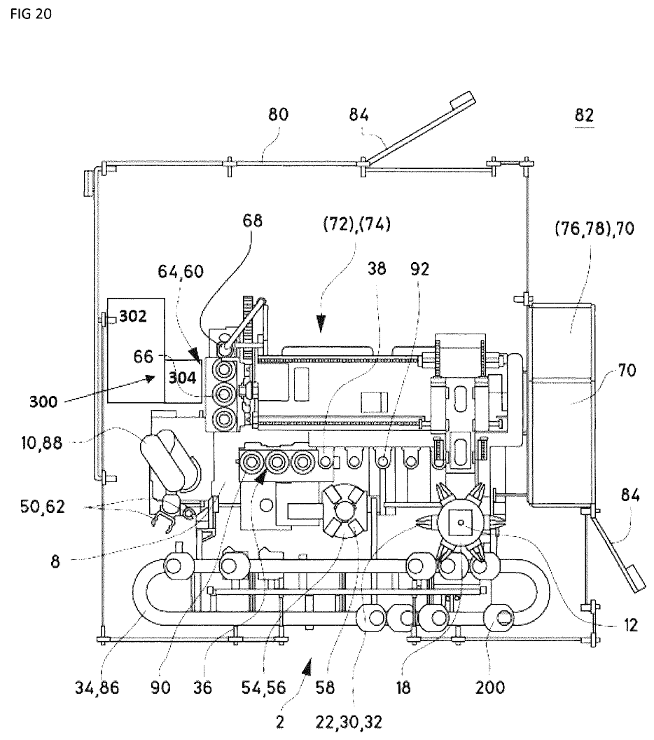

### Automated Shrink-Fitting Cell 2, or Shrink-Fitting Apparatus 2, for the Automated Shrink-Fitting and Removal of a Tool Into and From a Tool Holder Having an Ultrasonic Cleaning Facility 300 (FIG. 20)

FIG. 20 shows the—above-described—automated shrink-fitting cell 2. The structure and function/process have been described above—reference is made to the above text.

Furthermore, this shrink-fitting cell 2 according to FIG. 20 provides ultrasonic cleaning means—realized by an ultrasonic cleaning facility 300—comprised in ultrasound tanks 302 and also a drying facility 304—in this case for cleaning (and drying) tools 4 before the shrink-fitting operation.

Corresponding ultrasonic cleaning means correspondingly also can be used to clean tool holders/tools before the removal operation.

For the automated process in the shrink-fitting cell 2 and in particular the automated measurement there of the tools 4 or tool holders 6 (see above, cf. in particular embodiments regarding the measuring system 94 or (2) checking and validation of a tool 4, which is to be shrink-fitted (FIGS. 12 and 13), it is essential for the components, in particular the tool 4,—for the measurement—to be clean, i.e. free of dirt, oil, dust and the like. If dirty components were to be or are measured, the measurement results would be or are falsified, the result of which is then a reduction in quality in the course of the processing process during production. For quality control, clean components, or in particular clean tools 4, are essential. Grip regions on the tools 4 or tool holders 6 must also be free of dirt.

As FIG. 20 shows, the ultrasonic cleaning facility 300 provides an ultrasound tank 302—for instance with the dimensions 1 m×0.6 m×1.2 m (length/width/height)—filled with water and a cleaning liquid.

In order to keep the cleaning liquid clean, in the case of the ultrasound tank 302 an oil separator with an overflow function is furthermore provided. Sediment particles are removed from the bottom of the ultrasound tank 302 or from the ultrasound tank 302 by regular cleaning of the ultrasound tank 302.

In the case of the ultrasound tank 302, a water connection (, via which the ultrasound tank 302 can be refilled with water), a fill level indicator/measuring means and a temperature measuring means/controller having a temperature sensor in the ultrasound tank 302 are also provided. Further testing and analyzing units for testing the state of the cleaning liquid, such a refractometers or for determining the pH may be advantageous. The testing and analyzing units can be operated manually or in automated fashion.

A drying facility 304—for drying the cleaned tools 4—is provided directly next to the ultrasound tanks 302.

This drying facility 304 combines a wet-suction cleaning facility with a compressed-air drying effect, which on the one hand extracts liquid/moisture from the tool 4 and on the other hand blows it out. These two combined ensures the complete drying of the cleaned tools 4.

If now a tool 4—before the shrink-fitting operation—is cleaned (in which case a purely time-controlled cleaning process with predefined cleaning times in the ultrasound tank 302 and predefined drying times in the drying facility 304), the multiaxial articulated-arm robot 10 (with its articulated/gripper arm 88) grips the tool 4 (out of the conveying box 200—cf. process step g)) and dips it—holding it transversely—into the ultrasound tank 302.

The tool 4 in the ultrasound tank 302 is cleaned by ultrasonic cleaning while still being held by the multiaxial articulated-arm robot 10. Then, the multiaxial articulated-arm robot 10 lifts the (now cleaned, but wet) tool 4 out of the ultrasound tank 302—and displaces it into the drying facility, where it is dried—still being held by the multiaxial articulated-arm robot 10—by means of the combination of the wet-suction cleaning facility with a compressed-air drying effect. Analogously, the shrink-fit chuck or other individual parts of a chuck, such as collets and clamping nuts, can also be cleaned.

After that, the multiaxial articulated-arm robot 10 “transfers” the (cleaned and dried) tool 4 on to a transferring unit, where it is gripped and held thereby, in this case by the three-jaw chuck 96 (cg. FIGS. 12 and 13), (in such a way) that functional regions and grip regions (and also their overall length, among other things) are visible and can be checked or measured on the tool 4 (cf. above: (2)

checking and validation of a tool 4, which is to be shrink-fitted (FIGS. 12 and 13), measuring system 94,).

There, the tool 4 can be measured—using the measuring system 94 (see above, at the indicated point)—and its measured data compared with data-stored for this tool and retrieved from a database.

It is also possible for the tool 4 from there to continue to be displaced by means of the gripper tower 12 or gripper apparatus 22 (pincer gripper 22) there (cf. process step i)—see above). The centering station 56 (cf. process steps g), h) and i)) can be omitted.

### Conveying Box and/or Transportation Box 200 for Transportation of Tool Holders 6 and Tools 4 (FIGS. 6 to 9)

FIGS. 6 to 9 show—in various views—a conveying box and/or transportation box 200 for transportation of tool holders 6 and tools 4 (in short, simply conveying box 200 below), as can be used for example in the case of the automated shrink-fitting cell 2—for the transportation there of tool holders 6 and tools 4 (in particular to or away from the shrink-fitting unit 8 there, in particular on the conveyor belt 34 there) (see above).

The conveying box 200—here illustrated in FIGS. 6 to 9 with a received (rotary) tool 4, here for example a milling cutter 4, and a received tool holder 6, here for example a shrink-fit chuck 6,—provides a substantially cuboidal main body 202.

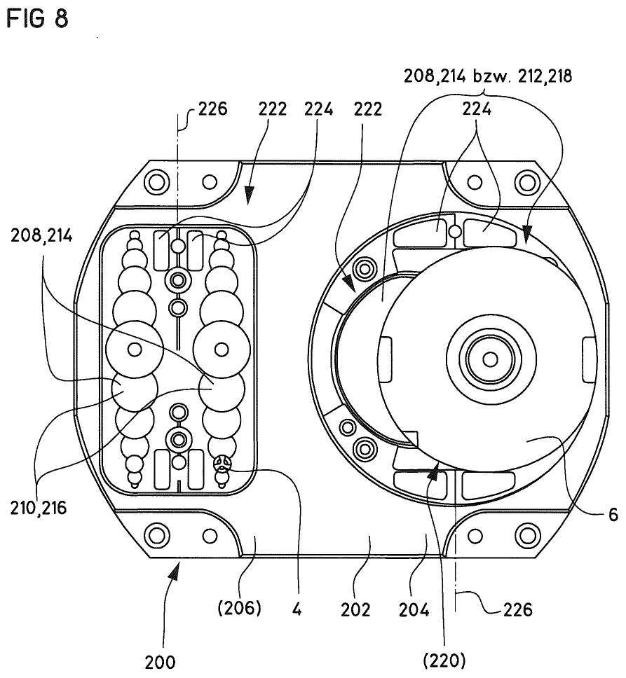

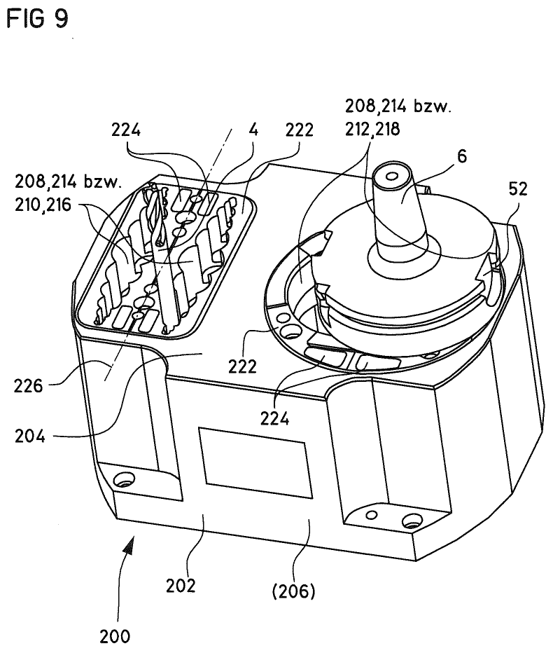

Arranged on an upper side 204 of the main body 202 are, as in particular FIGS. 8 and 9 show, a multiplicity of receiving openings 208, 210, 212, 214, 216, 218, which extend into an interior 206 of the main body 202 and are cylindrical (i.e. of substantially circular diameter), for tool holders 6 and tools 4.

The—multiple—receiving openings 210, 216 for the tools 4 are in this case, as in particular FIGS. 8 and 9 also show, arranged in blocks 222 in a left-hand half of the main body 202; in the region of the right-hand half of the main body 202, the receiving openings 212, 218 for the tool holders 6 are provided in blocks 222.

As in particular FIGS. 8 and 9 show, each receiving opening 208, 210, 212 has an associated identical (identically formed) receiving opening 214, 216, 218, which respective two thusly associated receiving openings 208, 210, 212 and 214, 216, 218 are arranged (in mirror-inverted fashion) relative to one another in the main body 202 of the conveying box 200.

Thus, as in particular FIGS. 8 and 9 show, the receiving openings 210, 214 for the tools 4 are arranged in two longitudinal rows situated opposite one another in mirror-inverted fashion, or symmetrically about a symmetry axis 226.

The same thus also applies for the receiving openings 212, 218 for the tool holders 6, it being the case here that, as FIGS. 8 and 9 show, there are “only” two receiving openings 212, 218, i.e. the first receiving opening 212 and its associated—mirror-inverted or symmetrically arranged—“mirror image” 218.

The receiving openings 210, 216 for the tools 4 have different diameters 26 (and depths 28), which are adapted to tool diameters 26 (and tool lengths 28), such that a multiplicity of tools 4 of different sizes can be received in the conveying box 200.

As in particular FIGS. 8 and 9 furthermore also show, the two associated receiving openings 212, 218 for a tool holder 6, i.e. the first receiving opening 212 and its associated—mirror-inverted or symmetrically arranged—“mirror image” 218, are arranged overlapping 220 one another.

This saves on space, but however also enables, given a corresponding “small” overlap 220, a secure hold/a securely holding receptacle for a tool holder 6 in the conveying box 220.

In order to be able to distinguish between the receiving openings 208, 210, 212, 214, 216, 218, i.e. on the one hand first receiving openings 208, 210, 212 and on the other hand their associated identical mirror-inverted receiving openings 214, 216, 218, provided on the conveying box 200 or at receiving openings 208, 210, 212, 214, 216, 218 there is a marker 224 in this respect—, which classifies the first receiving openings 208, 210, 212 as “good side” and their associated identical mirror-inverted receiving openings 214, 216, 218 as “bad side”.

Although the invention has been illustrated more specifically and described in detail by the preferred exemplary embodiments, the invention is not restricted by the examples disclosed and other variations may be derived therefrom without departing from the scope of protection of the invention.

The induction coil arrangement, ultrasound bath and conveying box can also be pursued as individual, separate inventive subject matter in the form of divisional applications as required.

### LIST OF DESIGNATIONS

2 Shrink-fitting apparatus, (automated) shrink-fitting cell
4 Tool, rotary tool, rotational tool, milling cutter, drill
6 Tool holder, shrink-fit receptacle/chuck
8 Shrink-fitting unit
10 First multiaxial handling apparatus, multiaxial articulated-arm robot
12 Second automatically displaceable handling apparatus, gripper tower
14 Uniaxial linear drive
16 Z axis
18 Gripper head
20 Angle measuring apparatus
22 Gripper apparatus, pincer gripper
24 Force measuring device, load cell
26 (Tool) diameter, diameter
28 (Tool) length, depth
30 (Movable, electromotively displaceable) gripper jaw
32 Stop lug
34 Conveyor device, conveyor belt
36 Spindle (of the shrink-fitting unit 8)
38 Induction coil arrangement
40 Horizontally
42 Vertically
44 Lifting travel monitoring device
46 Vertical displacement travel, lifting travel
48 Collision monitoring apparatus
50 Reading device/apparatus, measuring laser
52 Marker, tool holder code
54 Centering station
56 Centering jaw
58 Alignment control device, laser-based measuring system
60 Measuring device, measuring laser (tool measurement)
62 Double gripper (for tool and tool holder)
64 Cooling station
66 Spindle (of the cooling station 64)
68 Cooling attachment (can be fitted over, generation of eddy-current cooling (cyclone cooling) effect)
70 Switching cabinet
72 Balancing apparatus
74 Presetting device
76 Control computer
78 Control program, controller (on control computer 76)
80 Safety screen, fence
82 Surrounding area
84 (Safety) door (in 80)
86 Segment (of 34)
88 Articulated/gripper arm
90 Stage
92 Stop disk, ferrite disk, concentrator
94 (Further) measuring device, transmitted-light measuring system
96 (Further) holding apparatus, rotatable jaw chuck, 3-jaw chuck
102 Coil housing
104 Winding body
106 (Mechanical) contact switch (at the front)
108 (Mechanical) contact switch (at the rear)
110 Connecting/plug-in elements
112 Opening (for tool 4)
114 Clearance (for gripper apparatus/pincer gripper 22)
116 Grip element (on the stop disk 92 for the stop disk 92 to be gripped by way of the gripper apparatus/the pincer gripper 22)
118 Disk element (made of ferrite), ferrite disk/body
120 Mount (of the disk element 118)
122 (Left-hand) screwed connection (for fastening the induction coil arrangement 38 to the support 126)
124 (Right-hand) screwed connection (for fastening the induction coil arrangement 38 to the support 126)
126 Support (for induction coil arrangement 38) (cf. FIG. 4)
128 (Upper) fume extraction duct
130 (Lower) fume extraction duct
132 Slot
134 Fume extraction means
136 Annular duct
138 Openings in the annular duct 136
140 Connection (for compressed-air line for tool/tool holder cooling)
200 Conveying/transportation box, conveying/transportation container
202 Main body
204 Upper side (of 202)
206 Interior (of 202)
208 Receiving opening
210 Receiving opening for a tool
212 Receiving opening for a tool holder
214 Mirror-inverted, identical receiving opening
216 Mirror-inverted, identical receiving opening for a tool
218 Mirror-inverted, identical receiving opening for a tool holder
220 Overlap (of two associated receiving openings for a tool holder)
222 Arrangement in blocks
224 Marker, good/bad marker
226 Symmetry axis
300 Ultrasonic cleaning facility
302 (Ultrasonic cleaning) tank
304 Drying facility

1-42. (canceled)

43. A shrink-fitting apparatus for the automated shrink-fitting and removal of a tool into and from a tool holder, the shrink-fitting apparatus comprising:
a shrink-fitting unit configured for shrink-fitting a tool into a tool holder in a shrink-fitting operation or removing a tool from a tool holder in a removal operation;
a first multiaxial handling apparatus for transferring tool holders and tools in the shrink-fitting apparatus;
a second, automatically displaceable handling apparatus having a uniaxial linear drive configured to automatically displace the tool along one axis (Z axis) relative to the tool holder during the shrink-fitting operation or during the removal operation.

44. The shrink-fitting apparatus according to claim 43, wherein said second, automatically displaceable handling apparatus comprises a gripper head rotatable about the one axis (Z axis) and an angle measuring apparatus for measuring a rotational position of said gripper head.

45. The shrink-fitting apparatus according to claim 44, wherein said gripper head comprises multiple gripper apparatuses for gripping respective tools, and said multiple gripper apparatuses are arranged distributed about the one axis (Z axis) at predefined spacings.

46. The shrink-fitting apparatus according to claim 45, wherein said gripper head comprises force measuring devices for measuring a tensile force exerted by a respective said gripper apparatus on a tool.

47. The shrink-fitting apparatus according to claim 45, wherein said multiple gripper apparatuses are adapted to tools of predefinable diameters.

48. The shrink-fitting apparatus according to claim 45, wherein one or each of said gripper apparatuses has two gripper jaws, which during a gripping operation are movable relative to one another by electromotive displacement, and a gripping operation can be measured and/or monitored in terms of a gripping force, or one or each of said gripper jaws is provided with a stop lug.

49. The shrink-fitting apparatus according to claim 48, wherein said gripper jaws are exchangeably mounted and/or positionally accurately clamped in a respective said gripper apparatus.

50. The shrink-fitting apparatus according to claim 43, which comprises a conveyor device for transporting tool holders and tools to said shrink-fitting unit, said conveyor device being a circulating and segmented conveyor.

51. The shrink-fitting apparatus according to claim 43, wherein said shrink-fitting unit comprises multiple spindles, arranged next to one another and configured to hold tool holders in clamped fashion during the shrink-fitting operation, and said shrink-fitting unit comprises multiple induction coil arrangements, arranged next to one another and configured to heat tool holders.

52. The shrink-fitting apparatus according to claim 43, wherein said shrink-fitting unit comprises at least one spindle that is horizontally and/or vertically displaceable, and a lifting travel monitoring device for monitoring and/or measuring a vertical displacement travel during a vertical displacement of said at least one spindle.

53. The shrink-fitting apparatus according to claim 43, wherein said shrink-fitting unit comprises a collision monitoring apparatus configured to detect a collision between a tool holder and an induction coil arrangement.

54. The shrink-fitting apparatus according to claim 43, further comprising a reading apparatus associated with said first multiaxial handling apparatus and configured, when a tool holder is held in clamped fashion in a spindle of said shrink-fitting unit, to read a marker on said tool holder while the spindle is rotating.

55. The shrink-fitting apparatus according to claim 43, further comprising a centering station for clamping and aligning a tool.

56. The shrink-fitting apparatus according to claim 55, further comprising an alignment control device arranged in a region of said centering station and configured to determine and/or monitor an alignment of a tool that has been removed from said centering station by said second, automatically displaceable handling apparatus.

57. The shrink-fitting apparatus according to claim 43, further comprising a measuring device for measuring a workpiece.

58. The shrink-fitting apparatus according to claim 57, further comprising a further measuring device for measuring at least one of a tool or a tool holder with or without a tool.

59. The shrink-fitting apparatus according to claim 58, wherein said further measuring device is an optical transmitted-light or incident-light measuring system.

60. The shrink-fitting apparatus according to claim 58, wherein said further measuring device is displaceable in at least two spatial directions, including substantially along the one axis (Z axis) or substantially transversely to the one axis (Z axis).

61. The shrink-fitting apparatus according to claim 43, further comprising a further holding apparatus configured to clamp and hold a tool during a checking operation using a further measuring device.

62. The shrink-fitting apparatus according to claim 61, wherein said further holding apparatus comprises a rotatable jaw chuck.

63. The shrink-fitting apparatus according to claim 61, wherein said further holding apparatus is at least one of horizontally displaceable, transversely to the one axis (Z axis), or vertically, substantially along the one axis (Z axis).

64. The shrink-fitting apparatus according to claim 43, wherein said first multiaxial handling apparatus is a multiaxial articulated-arm robot comprising a double gripper for gripping a tool and for gripping a tool holder.

65. The shrink-fitting apparatus according to claim 43, further comprising a cooling station for cooling tool holders heated by the shrink-fitting operation, said cooling station having multiple spindles arranged next to one another and configured to hold tool holders in clamped fashion during a cooling operation and/or having a cooling attachment, to be fitted over said tool holders held on said spindles and configured to generate an eddy-current cooling and cyclone cooling effect.

66. The shrink-fitting apparatus according to claim 43, further comprising a cleaning apparatus, being an ultrasonic cleaning device, and/or an induction coil arrangement having an exchangeable stop disk, to be exchanged automatically upon a parameter selection.

67. The shrink-fitting apparatus according to claim 43, further comprising at least one of the following: a switching cabinet, a balancing apparatus, a presetting apparatus, or a control computer with a control program stored thereon for a controller of the shrink-fitting apparatus.

68. The shrink-fitting apparatus according to claim 43, further comprising a safety screen configured to screen wide regions of the shrink-fitting apparatus from an area surrounding the shrink-fitting apparatus.

69. A shrink-fitting method, comprising:
providing an apparatus for automated shrink-fitting a tool into a tool holder in a shrink-fitting operation or removing the tool from the tool holder in a removal operation; and
using a uniaxial linear drive of a second, automatically displaceable handling apparatus to automatically displace the tool along one axis (Z axis) relative to the tool holder during the shrink-fitting operation and/or during the removal operation.

70. The method according to claim 69, which comprises carrying out at least one, or several, or all of the following method steps:
(a) loading a conveying box, arranged on a conveyor device, with a tool to undergo shrink-fitting and/or a tool holder and/or with a tool holder having a tool to be removed or depositing a conveying box, filled with a tool to undergo shrink-fitting and a tool holder or a tool holder having a tool to be removed, on a conveyor device,
(b) transporting a conveying box, loaded with a tool to undergo shrink-fitting and a tool holder or a tool holder having a tool to be removed, by means of a conveyor device to the shrink-fitting unit, in particular to the vicinity of a clamping spindle of the shrink-fitting unit,
(c) transferring a tool holder from a conveying box to a spindle of the shrink-fitting unit, in particular using a first multiaxial handling apparatus for transferring tool holders and tools,
(d) clamping a tool holder on a spindle of the shrink-fitting unit,
(e) rotating a tool holder clamped on a spindle of the shrink-fitting unit, in particular about the one axis (Z axis) and in particular by 360°, and reading a marker applied to the tool holder, in particular a tool holder code applied to the tool holder,
(f) providing tool holder and/or tool and/or shrink-fit data or parameters using a marker applied to the tool holder and read, in particular a tool holder code applied to the tool holder and read,
(g) transferring a tool from a conveying box to a centering station, in particular using a first multiaxial handling apparatus for transferring tool holders and tools,
(h) clamping and/or aligning a tool in a centering station,
(i) gripping a tool, which is clamped in a centering station, by means of the second, automatically displaceable handling apparatus, in particular such that the tool after the shrink-fitting operation into a tool holder has a predefinable position in the tool holder,
(j) measuring a tool gripped by the second, automatically displaceable handling apparatus, in particular using a measuring laser and/or in particular measuring an alignment of the tool, in particular in terms of the one axis (Z axis) or a geometry,
(k) displacing a tool holder clamped on a spindle of the shrink-fitting unit, in particular displacing the tool holder to underneath an induction coil arrangement of the shrink-fitting unit in the continuation of the one axis (Z axis),
(l) ascertaining a lifting travel of a tool holder clamped on a spindle of the shrink-fitting unit, in particular along the one axis (Z axis) and in particular using a geometry of the tool holder,
(m) lifting a tool holder clamped on a spindle of the shrink-fitting unit, in particular along the one axis (Z axis), in particular until the tool holder comes into abutment in an induction coil arrangement, in particular comes into abutment with stop disks of the induction coil arrangement,
(n) monitoring a lifting operation of a tool holder clamped on a spindle of the shrink-fitting unit in terms of a lifting travel and/or a collision with an induction coil arrangement, in particular a collision with stop disks of the induction coil arrangement,
(o) heating a tool holder using an induction coil arrangement of the shrink-fitting unit,
(p) gripping a tool, which is arranged in a tool holder, by way of the second, automatically displaceable handling apparatus and displacing the tool, that is gripped by the second, automatically displaceable handling apparatus, along the one axis (Z axis) out of the tool holder, in particular while monitoring the displacement of the gripped tool in terms of a tensile force exerted on the tool (to be removed),
(q) pivoting a gripper head of the second, automatically displaceable handling apparatus,
(r) displacing a tool, that is gripped by the second, automatically displaceable handling apparatus, along the one axis (Z axis) relative to the tool holder into a predefinable shrink-fit position with respect to the tool holder, in particular displacing the tool, that is gripped by the second, automatically displaceable handling apparatus, along the one axis (Z axis) relative to the tool holder until gripper lugs of a gripper head of the second, automatically displaceable handling apparatus rest on an upper end face of the tool holder or on a stop disk of the induction coil arrangement,
(s) temporarily holding a tool by means of the second, automatically displaceable handling apparatus, in particular at least until the tool is clamped by means of cooling the tool holder,
(t) lowering a tool holder, that is clamped on a spindle of the shrink-fitting unit, in particular along the one axis (Z axis),
(u) transferring a tool holder, that is clamped on a spindle of the shrink-fitting unit, to a cooling station using a first multiaxial handling apparatus,
(v) cooling a tool holder, in particular using an eddy-current cooling effect,
(w) transferring a tool holder to a balancing apparatus and/or to a presetting apparatus using a first multiaxial handling apparatus,
(x) measuring a tool holder, in particular in a presetting device or in a cooling station or in a balancing apparatus,
(y) displacing a tool by means of the second, automatically displaceable handling apparatus, in particular to a conveying box and/or to a centering station, and
(z) transferring a tool holder to a conveying box.

71. The method according to claim 69, which further comprises monitoring and/or checking the tool and/or the tool holder, with or without a tool, using at least one of a measuring system or a further holding apparatus.

72. The method according to claim 71, which comprises monitoring or checking the tool holder, with or without a tool, by displacing the further measuring system substantially along the one axis (Z axis), and measuring at least one of an overall length of the tool holder with the tool, a cutting-edge diameter, a tool shaft diameter within a given shaft tolerance), or a length A dimension, and carrying out collision checks.

73. The method according to claim 71, which further comprises monitoring or checking the tool, with the tool being held in and made to rotate by the further holding apparatus.

74. The method according to claim 71, which further comprises monitoring or checking the tool with the further measuring system by checking at least one of an uppermost point of the tool, a grip region on the tool, a tool length, a tool diameter, or a tool shaft diameter, and comprehensively checking and validating the tool, and carrying out a collision check.

75. The method according to claim 69, which further comprises monitoring or checking the tool holder during the shrink-fitting operation and/or during the removal operation, by checking whether or not the tool can be removed from the tool holder.

76. The method according to claim 71, which further comprises, concurrently with the monitoring or checking, effecting corrections during the shrink-fitting operation or removal operation using information obtained from the monitoring or checking.

77. The method according to claim 76, which comprises correcting a length of the complete tool formed by the tool and the tool holder during the shrink-fitting operation.

78. The method according to claim 69, which comprises centering and aligning a tool to undergo shrink-fitting by rotating a tool holder while the tool to undergo shrink-fitting is being inserted into the tool holder.

79. A conveying box for tool holders and/or tools to be used in a shrink-fitting operation, the conveying box comprising:
a main body having an upper side and a multiplicity of receiving openings for tool holders and tools formed in the upper side and extending into an interior of said main body; and
each receiving opening for a tool holder or for a tool, arranged in said main body, having an identical receiving opening arranged in mirror-inverted fashion on said main body.

80. The conveying box according to claim 79, wherein said receiving openings for the tools are adapted to at least one of tool diameters or tool lengths of the tools.

81. The conveying box according to claim 79, wherein the respectively associated receiving openings for a tool holder are arranged overlapping one another.

82. The conveying box according to claim 79, wherein said receiving openings for the tools, on the one hand, and the receiving openings for the tool holders, on the other hand, are arranged in blocks or are offset from one another in the main body.

83. The conveying box according to claim 79, wherein said receiving openings for the tools and said receiving openings for the tool holders, on the one hand, and their identical receiving openings arranged in mirror-inverted fashion, on the other hand, have markers that distinguishes between them.

84. The conveying box according to claim 79, configured for transportation of tool holders and/or tools in a shrink-fitting apparatus for the automated shrink-fitting and removal of a tool into and from a tool holder, wherein the shrink-fitting apparatus comprises:
a shrink-fitting unit configured for shrink-fitting a tool into a tool holder in a shrink-fitting operation or removing a tool from a tool holder in a removal operation;
a first multiaxial handling apparatus for transferring tool holders and tools in the shrink-fitting apparatus;
a second, automatically displaceable handling apparatus having a uniaxial linear drive configured to automatically displace the tool along one axis (Z axis) relative to the tool holder during the shrink-fitting operation or during the removal operation.
